(19) United States
(12) Patent Application Publication
(10) Pub. No.: US 2024/0302597 A1
(43) Pub. Date: Sep. 12, 2024

(54) SPOT SIZE CONVERTER

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Yuki KAMATA, Nisshin-shi (JP); Toshihiro ODA, Nisshin-shi (JP)

(21) Appl. No.: 18/437,287

(22) Filed: Feb. 9, 2024

(30) Foreign Application Priority Data
Mar. 7, 2023 (JP) 2023-034615

(51) Int. Cl. G02B 6/30; G02B 6/036; G02F 1/01

(52) U.S. Cl. CPC G02B 6/305; G02B 6/036; G02F 1/0115

(57) ABSTRACT

A spot size converter includes: a first core layer extending in a first direction and stacked on a cladding layer in a second direction; and a second core layer spaced apart from the first core layer in a third direction. The first core layer has a flat shape in which a size in the second direction is smaller than a size in the third direction, and includes a first tapered portion in which a size thereof in the third direction decreases along an emission direction. A size of the second core layer in the second direction is larger than that of the first core layer in the second direction, and includes a second tapered portion in which a size thereof in the third direction increases along the emission direction. The second tapered portion is disposed to overlap the first tapered portion in the third direction.

### CROSS REFERENCE TO RELATED APPLICATION

This application is based on Japanese Patent Application No. 2023-034615 filed on Mar. 7, 2023, the disclosure of which is incorporated herein by reference.

### TECHNICAL FIELD

The present disclosure relates to a spot size converter.

### BACKGROUND

An upper core layer and a lower core layer are stacked to form a waveguide path in a dual-mesa tapered spot size converter. The spot size converter is provided, for example, between a laser module and an optical fiber. Waveguide paths of the laser module and the optical fiber have different cross-sectional areas orthogonal to an emission direction of a laser light in the waveguide paths. The spot size converter is used to efficiently couple the waveguide path of the laser module that emits the laser light and the waveguide path of the optical fiber that receives the laser light emitted from the laser module.

### SUMMARY

A spot size converter emits a laser light in an emission direction, and includes: a first core layer stacked on a cladding layer and extending in a first direction which is a direction along the emission direction; and a second core layer, when a direction in which the cladding layer and the first core layer are stacked is a second direction and a direction orthogonal to the first direction and the second direction is a third direction, the second core layer being spaced apart from the first core layer on at least one of one side and another side of the first core layer in the third direction, and extending in the first direction. The first core layer has a flat shape in which a size in the second direction is smaller than a size in the third direction, and includes a first tapered portion in which a size thereof in the third direction decreases along the emission direction. The second core layer is formed such that a size thereof in the second direction is larger than the size of the first core layer in the second direction, and includes a second tapered portion in which a size thereof in the third direction increases along the emission direction. The second tapered portion is disposed at a position overlapping at least a part of the first tapered portion in the third direction.

### BRIEF DESCRIPTION OF DRAWINGS

FIG. 1 is a top view of a spot size converter according to a first embodiment;

FIG. 2 is a cross-sectional view taken along a line II-II shown in FIG. 1;

FIG. 3 is a cross-sectional view taken along a line III-III shown in FIG. 1;

FIG. 4 is a diagram showing an optical fiber connected to the spot size converter;

FIG. 5 is a diagram showing an optical integrated circuit connected to the spot size converter;

FIG. 6 is a diagram showing an electric field intensity distribution of the optical fiber;

FIG. 7 is a diagram showing an electric field intensity distribution of the optical integrated circuit;

FIG. 8 is a perspective view of a comparative converter;

FIG. 9 is a top view of the comparative converter viewed in an arrow direction IX of FIG. 8;

FIG. 10 is a cross-sectional view taken along a line X-X shown in FIG. 8;

FIG. 11 is a diagram showing an electric field intensity distribution of the comparative converter;

FIG. 12 is a diagram showing a relationship between a taper length and a coupling efficiency of the comparative converter;

FIG. 13 is a diagram showing the coupling efficiency of the comparative converter;

FIG. 14 is a diagram showing an electric field intensity distribution of the spot size converter according to the first embodiment;

FIG. 15 is a diagram showing a relationship between a taper length and a coupling efficiency of the spot size converter according to the first embodiment;

FIG. 16 is a diagram showing the coupling efficiency of the spot size converter according to the first embodiment;

FIG. 17 is a top view of a spot size converter according to a second embodiment;

FIG. 18 is a cross-sectional view taken along a line XVIII-XVIII shown in FIG. 17;

FIG. 19 is a cross-sectional view taken along a line XIX-XIX shown in FIG. 17;

FIG. 20 is a diagram showing a coupling efficiency of the spot size converter according to the second embodiment;

FIG. 21 is a top view of a spot size converter according to a third embodiment;

FIG. 22 is a cross-sectional view taken along a line XXII-XXII shown in FIG. 21;

FIG. 23 is a cross-sectional view taken along a line XXIII-XXIII shown in FIG. 21;

FIG. 24 is a diagram showing an electric field intensity distribution of the spot size converter according to the third embodiment;

FIG. 25 is a diagram showing a relationship between a taper length and a coupling efficiency of the spot size converter according to the third embodiment;

FIG. 26 is a diagram showing a coupling efficiency of the spot size converter according to the third embodiment;

FIG. 27 is a top view of a spot size converter according to a fourth embodiment;

FIG. 28 is a cross-sectional view taken along a line XXVIII-XXVIII shown in FIG. 27;

FIG. 29 is a cross-sectional view taken along a line XXIX-XXIX shown in FIG. 27;

FIG. 30 is a diagram showing a coupling efficiency of the spot size converter according to the fourth embodiment;

FIG. 31 is a top view of a spot size converter according to a fifth embodiment;

FIG. 32 is a cross-sectional view taken along a line XXXII-XXXII shown in FIG. 31;

FIG. 33 is a cross-sectional view taken along a line XXXIII-XXXIII shown in FIG. 31;

FIG. 34 is a diagram showing a coupling efficiency of the spot size converter according to the fifth embodiment;

FIG. 35 is a top view of a spot size converter according to a sixth embodiment;

FIG. 36 is a cross-sectional view taken along a line XXXVI-XXXVI shown in FIG. 35;

FIG. 37 is a cross-sectional view taken along a line XXXVII-XXXVII shown in FIG. 35;

FIG. 38 is a diagram showing a coupling efficiency of the spot size converter according to the sixth embodiment;

FIG. 39 is a top view of a spot size converter according to a seventh embodiment;

FIG. 40 is a top view of a spot size converter according to an eighth embodiment;

FIG. 41 is a top view of a spot size converter according to a ninth embodiment;

FIG. 42 is a top view of a spot size converter according to a tenth embodiment; and

FIG. 43 is a top view of a spot size converter according to an eleventh embodiment.

### DESCRIPTION OF EMBODIMENTS

An upper core layer and a lower core layer are stacked to form a waveguide path in a dual-mesa tapered spot size converter. The spot size converter is provided, for example, between a laser module and an optical fiber. Waveguide paths of the laser module and the optical fiber have different cross-sectional areas orthogonal to an emission direction of a laser light in the waveguide paths. The spot size converter is used to efficiently couple the waveguide path of the laser module that emits the laser light and the waveguide path of the optical fiber that receives the laser light emitted from the laser module.

In the spot size converter, when a laser light is incident from an end portion of the upper core layer on one side in the emission direction of the laser light, the laser light transitions to the lower core layer at an end portion of the upper core layer on the other side in the emission direction of the laser light. The laser light that has transitioned to the lower core layer is emitted from the end portion of the lower core layer on the other side in the emission direction of the laser light.

A mesa width of the upper core layer of the spot size converter decreases along the emission direction of the laser light. Regarding this, the lower core layer has a thin flat shape in which a mesa width increases along the emission direction of the laser light and a size in a stacking direction is smaller than a size in a width direction.

In the spot size converter configured as described above, optical confinement is gradually weakened along the emission direction of the laser light in the upper core layer in which the mesa width decreases along the emission direction of the laser light. Therefore, the laser light propagated through the upper core layer gradually transitions to the lower core layer.

In the lower core layer in which the mesa width increases along the emission direction of the laser light, an electric field intensity distribution of the lower core layer in the width direction is expanded along the emission direction of the laser light. Further, in the lower core layer having the thin flat shape, the optical confinement in the stacking direction is reduced. Therefore, the electric field intensity distribution of the lower core layer in the stacking direction is expanded.

Accordingly, the spot size converter can expand an electric field intensity distribution of the laser light emitted from the laser module so as to approach an electric field intensity distribution of the laser light propagated to the waveguide path of the optical fiber. The spot size converter can efficiently couple the waveguide path of the laser module and the waveguide path of the optical fiber.

The inventors have studied that a spot size converter is provided between an optical fiber and an optical integrated circuit, and a laser light emitted from the optical fiber is guided to the optical integrated circuit via the spot size converter. A size of a cross-sectional shape of a waveguide path of the optical integrated circuit orthogonal to an emission direction is significantly smaller than that of a waveguide path of the optical fiber. The spot size converter in this case is required to efficiently couple the waveguide path of the optical fiber and the waveguide path of the optical integrated circuit by bringing an electric field intensity distribution of the laser light emitted from the optical fiber close to an electric field intensity distribution of the laser light propagated through the waveguide path of the optical integrated circuit.

The inventors have studied that the laser light emitted from the optical fiber is incident from an end portion of a lower core layer on the other side in an emission direction of the laser light and is emitted to the optical integrated circuit from an end portion of an upper core layer on one side in the emission direction of the laser light.

However, according to intensive studies by the inventors, a width of an end portion of the upper core layer on a side to which the lower core layer is connected (that is, the end portion of the upper core layer on a side opposite to the emission direction) is at least about several 100 nm due to limitation in manufacturing.

In such a spot size converter, among the waveguide paths formed by the lower core layer and the upper core layer, a cross-sectional shape of the waveguide path orthogonal to the emission direction immediately before the laser light passes through the end portion of the upper core layer on the side opposite to the emission direction is a thin flat shape corresponding to a shape of the lower core layer. Regarding this, a cross-sectional shape of the waveguide path orthogonal to the emission direction immediately after the laser light passes through the end portion of the upper core layer on the side opposite to the emission direction is a cross-sectional shape in which the upper core layer is stacked on the lower core layer. The cross-sectional shape is a shape in which the upper core layer having a rectangular cross-sectional shape and a width of about several 100 nm is stacked on the lower core layer having the thin flat shape.

Accordingly, for the cross-sectional shape of the waveguide path orthogonal to the emission direction in the spot size converter, the shape immediately after the laser light passes through the end portion of the upper core layer on the side opposite to the emission direction is a shape in which the rectangular shape protrudes on the thin flat shape. Accordingly, immediately after the laser light passes through the end portion of the upper core layer on the side opposite to the emission direction, optical confinement in a direction in which the lower core layer and the upper core layer are stacked rapidly changes.

According to the intensive studies by the inventors, it has been found that, when the optical confinement of the waveguide path rapidly changes in the spot size converter, the electric field intensity distribution of the laser light rapidly changes when the laser light passes through a portion at which the optical confinement rapidly changes. It is found that when the electric field intensity distribution rapidly changes, loss occurs when the light is propagated in the spot size converter. The loss causes deterioration in transmission efficiency when the light is propagated through the waveguide path in the spot size converter, and causes deterioration in coupling efficiency when the spot size converter couples two waveguide paths having different cross-sectional areas orthogonal to the emission direction of the laser light.

The present disclosure provides a spot size converter capable of improving coupling efficiency.

A spot size converter emits a laser light in a predetermined emission direction, and includes: a first core layer stacked on a cladding layer and extending in a first direction which is a direction along the emission direction; and a second core layer, when a direction in which the cladding layer and the first core layer are stacked is a second direction and a direction orthogonal to the first direction and the second direction is a third direction, the second core layer being spaced apart from the first core layer on at least one of one side and another side of the first core layer in the third direction, and extending in the first direction. The first core layer has a flat shape in which a size in the second direction is smaller than a size in the third direction, and includes a first tapered portion in which a size thereof in the third direction decreases along the emission direction. The second core layer is formed such that a size thereof in the second direction is larger than the size of the first core layer in the second direction, and includes a second tapered portion in which a size thereof in the third direction increases along the emission direction. The second tapered portion is disposed at a position overlapping at least a part of the first tapered portion in the third direction.

Accordingly, the laser light transitions from a first tapered portion positioned on an end portion of a first core layer in the emission direction to a second tapered portion positioned on an end portion of a second core layer in an emission reverse direction.

The first core layer can confine expansion of the laser light in a third direction in the end portion of the first core layer in the emission direction. Therefore, even in a configuration in which the second core layer is provided on at least one of one side and the other side in the third direction in the end portion of the first core layer in the emission direction, a change in the optical confinement in the third direction caused by the presence of the second core layer can be limited.

Accordingly, the spot size converter can limit a change in the electric field intensity distribution of the laser light when the laser light passes through the end portion of the second core layer on a direction side opposite to the emission direction. By reducing the change in the electric field intensity distribution, the loss occurs when the light is propagated can be reduced, and deterioration in light transmission efficiency can be reduced.

Accordingly, it is possible to improve the coupling efficiency when coupling two waveguide paths having different cross-sectional areas orthogonal to the emission direction of the laser light.

Hereinafter, embodiments according to the present disclosure will be described with reference to the drawings. In the following embodiments, parts that are the same as or equivalent to matters described in a preceding embodiment are denoted by the same reference numerals, and description thereof may be omitted. When only a part of components is described in an embodiment, components described in the preceding embodiment can be applied to other parts of the components. In the following embodiments, the embodiments can be partially combined with each other as long as the embodiments do not cause any trouble in combination, even if the combination is not specified in particular.

### First Embodiment

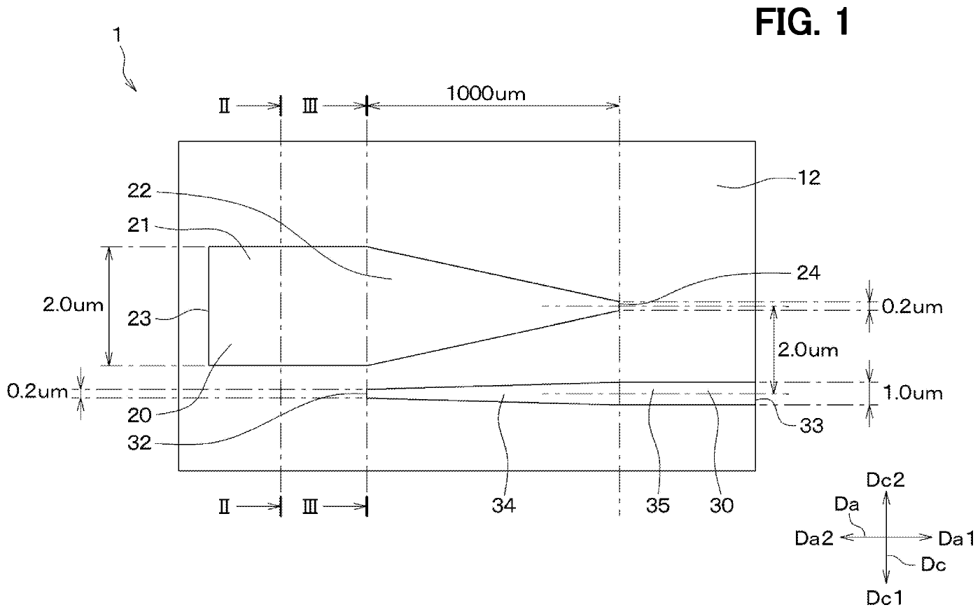

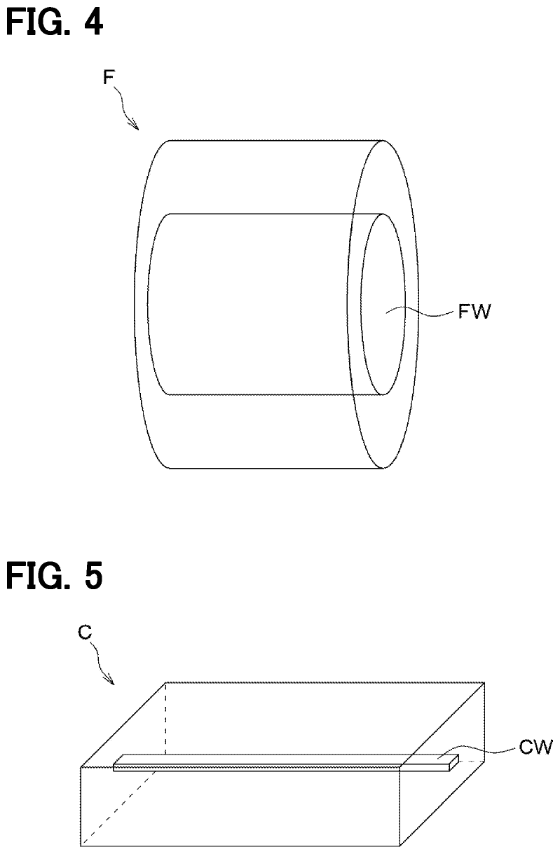

A spot size converter 1 according to the present embodiment will be described with reference to FIGS. 1 to 16. The spot size converter 1 according to the present embodiment shown in FIGS. 1 to 3 is used to efficiently couple two waveguide paths having different cross-sectional areas orthogonal to an emission direction of a laser light. For example, the spot size converter 1 according to the present embodiment is provided between an optical fiber waveguide path FW of an optical fiber F and a circuit waveguide path CW of an optical integrated circuit C having different cross-sectional areas orthogonal to the emission direction of the laser light as shown in FIGS. 4 and 5. The spot size converter 1 efficiently couples the optical fiber waveguide path FW and the circuit waveguide path CW.

A core diameter of the optical fiber waveguide path FW is generally about 10 μm. Regarding this, the circuit waveguide path CW generally has a rectangular cross-sectional shape orthogonal to the emission direction of the laser light, and sizes of four sides forming the rectangular shape are 1 μm or less. As described above, a size of the cross-sectional shape of the circuit waveguide path CW orthogonal to the emission direction is significantly smaller than that of the optical fiber waveguide path FW.

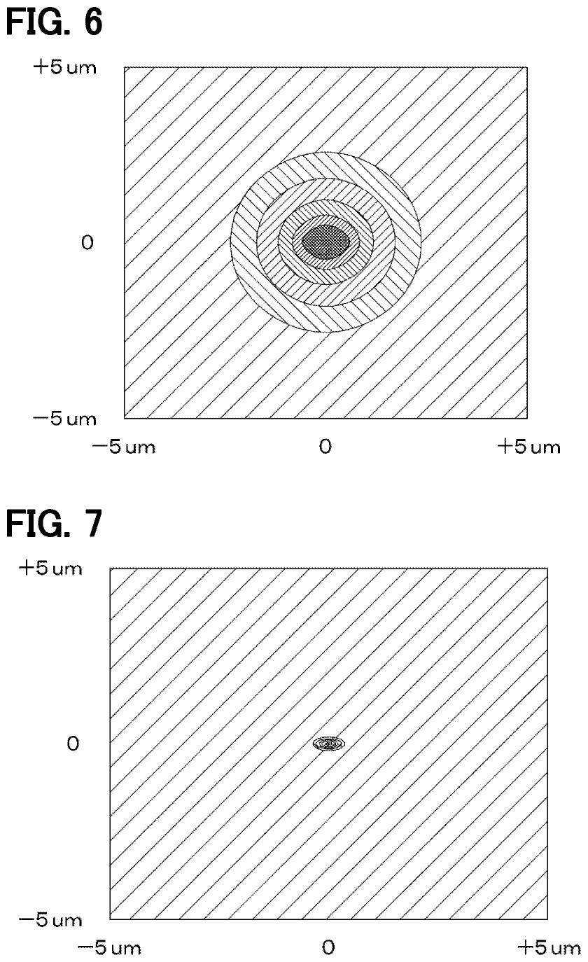

As shown in FIGS. 6 and 7, an electric field intensity distribution of a laser light propagated through the circuit waveguide path CW greatly deviates from an electric field intensity distribution of a laser light propagated through the optical fiber waveguide path FW. Therefore, when the optical fiber waveguide path FW and the circuit waveguide path CW are directly coupled, a coupling efficiency between the optical fiber waveguide path FW and the circuit waveguide path CW is relatively low. For example, when there is peeling of the electric field intensity distributions as shown in FIGS. 6 and 7, the coupling efficiency between the optical fiber waveguide path FW and the circuit waveguide path CW is 7.2%. In FIGS. 6, FIG. 7 and FIG. 11 to be described later, an intensity of the electric field intensity distribution is indicated by a density of hatching. As the intensity of the electric field intensity distribution is higher, the density of hatching is larger.

The spot size converter 1 efficiently couples the optical fiber waveguide path FW and the circuit waveguide path CW by bringing the electric field intensity distribution of the circuit waveguide path CW and the electric field intensity distribution of the optical fiber waveguide path FW close to each other. In the present embodiment, an example will be described in which an input side of the spot size converter 1 is connected to a side of the optical fiber F from which the laser light is emitted and an output side of the spot size converter 1 is connected to a side of the optical integrated circuit C on which the laser light is incident, and the laser light emitted from the optical fiber F is guided to the optical integrated circuit C.

As shown in FIGS. 1 to 3, the spot size converter 1 according to the present embodiment includes multiple cladding layers 11, 12, and 13 and multiple core layers 20 and 30. The multiple cladding layers 11, 12, and 13 and the multiple core layers 20 and 30 are stacked on a substrate (not shown). Specifically, the spot size converter 1 includes the first cladding layer 11 provided on the substrate (not shown), the second cladding layer 12 and the second core layer 30 provided on the first cladding layer 11, and the first core layer 20 provided on the second cladding layer 12. The spot size converter 1 includes the third cladding layer 13 covering the first core layer 20 and the second core layer 30. Hereinafter, the first cladding layer 11, the second cladding layer 12, and the third cladding layer 13 may be referred to as the first cladding layer 11 to the third cladding layer 13. In FIG. 1, the third cladding layer 13 is omitted.

The first core layer 20 and the second core layer 30 have a refractive index larger than that of the first cladding layer 11, the second cladding layer 12, and the third cladding layer 13. Therefore, the first core layer 20 and the second core layer 30 function as optical waveguide paths for guiding the laser light incident from the optical fiber F to the optical integrated circuit C in the spot size converter 1.

Hereinafter, as shown in FIG. 1 and the like, a direction along a direction in which the laser light is propagated in the spot size converter 1 is defined as a first direction Da. The first direction Da is a direction along a direction in which the spot size converter 1 emits the laser light. A direction in which the spot size converter 1 emits the laser light in the first direction Da is defined as an emission direction Da1, and a direction opposite to the emission direction Da1 is defined as an emission reverse direction Da2.

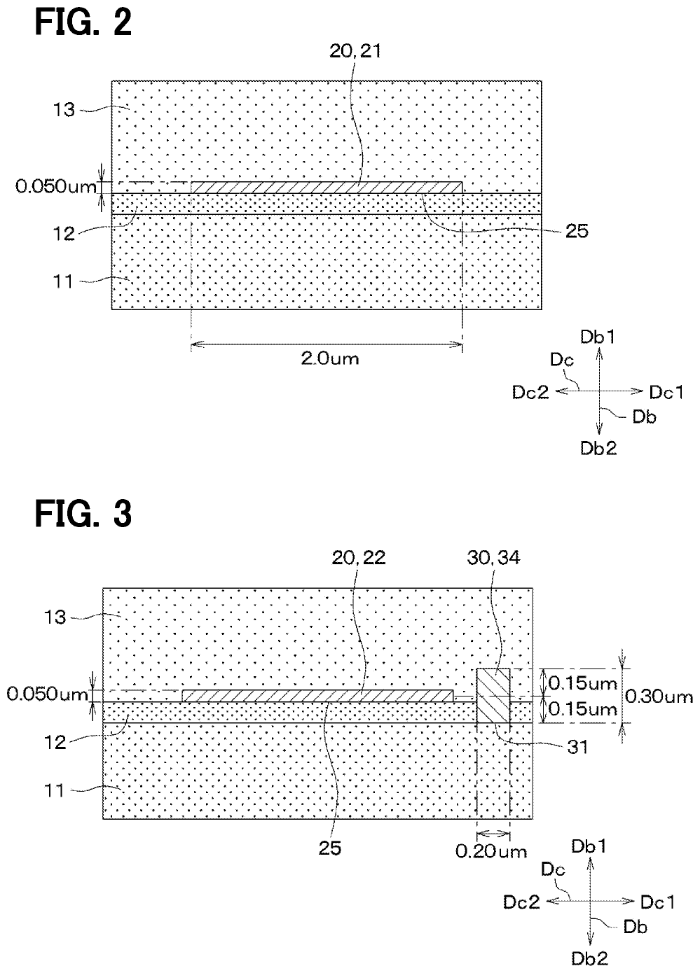

As shown in FIG. 2, FIG. 3, and the like, a direction in which the first core layer 20, the second core layer 30, the first cladding layer 11, the second cladding layer 12, and the third cladding layer 13 are stacked is defined as a second direction Db, and a direction orthogonal to the first direction Da and the second direction Db is defined as a third direction Dc. A direction in which the first cladding layer 11, the second cladding layer 12, the first core layer 20, and the third cladding layer 13 are stacked in this order in the second direction Db is defined as a stacking forward direction Db1, and a direction opposite to the stacking forward direction Db1 is defined as a stacking reverse direction Db2. One side in the third direction Dc is defined as a one-side third direction Dc1, and a direction opposite to the one-side third direction Dc1 is defined as the other-side third direction Dc2.

As shown in FIGS. 1 and 2, the first cladding layer 11 is formed in a cubic shape whose longitudinal direction is the first direction Da. As shown in FIG. 3, the second cladding layer 12 and the second core layer 30 are provided on the first cladding layer 11. The second cladding layer 12 is provided on a portion of the first cladding layer 11 other than a portion on which the second core layer 30 is provided. A size of the second cladding layer 12 in the second direction Db is smaller than a size of the second core layer 30 in the second direction Db. That is, the second core layer 30 protrudes from the second cladding layer 12 in the stacking forward direction Db1.

The first core layer 20 is provided on the second cladding layer 12. The third cladding layer 13 is provided on the second cladding layer 12 and covers portions of the first core layer 20 and the second core layer 30 protruding from the second cladding layer 12.

The first cladding layer 11, the second cladding layer 12, and the third cladding layer 13 are made of, for example, silicon oxide (that is, SiO₂) as an insulator.

As shown in FIGS. 1 and 2, the first core layer 20 extends along the first direction Da at a substantially center on the second cladding layer 12 in the third direction Dc. The first core layer 20 is formed in a thin flat shape in which a size of the first core layer 20 in the second direction Db is smaller than a size thereof in the third direction Dc. In the first core layer 20 according to the present embodiment, the size in the second direction Db is significantly smaller than the size in the third direction Dc. The first core layer 20 is made of silicon nitride (that is, SiN). The first core layer 20 is spaced apart from an end portion of the spot size converter 1 in the emission reverse direction Da2.

The first core layer 20 includes a first propagation portion 21 and a first tapered portion 22. The first propagation portion 21 and the first tapered portion 22 are provided in this order along the emission direction Da1.

The first core layer 20 has a first emission reverse side surface 23 on the end portion in the emission reverse direction Da2, and a first emission side surface 24 on an end portion in the emission direction Da1. The first emission reverse side surface 23 is a surface that receives the laser light emitted from the optical fiber waveguide path FW. The first emission reverse side surface 23 is a surface closer to the end portion of the spot size converter 1 in the emission reverse direction Da2 than the first emission side surface 24, and is spaced apart from the end portion of the spot size converter 1 in the emission reverse direction Da2. The first emission side surface 24 is a surface opposite to the first emission reverse side surface 23 on the first core layer 20.

As shown in FIG. 2, the first core layer 20 has a first core surface 25 that is a surface on the second cladding layer 12 side in the second direction Db. The first core surface 25 is a surface in contact with the second cladding layer 12 on which the first core layer 20 is provided.

The first propagation portion 21 is a portion optically coupled to the optical fiber waveguide path FW, and guides the laser light propagated from the optical fiber waveguide path FW in the emission direction Da1. A size of the first propagation portion 21 in the second direction Db and a size of the first propagation portion 21 in the third direction Dc from the end portion on the emission reverse direction Da2 side in the first direction Da to an end portion on the emission direction Da1 side are constant. Specifically, the size of the first propagation portion 21 in the second direction Db is 0.050 μm and the size of the first propagation portion 21 in the third direction Dc is 2.0 μm. The first propagation portion 21 is provided on the emission reverse direction Da2 side with respect to the second core layer 30. That is, the first propagation portion 21 is provided at a position not overlapping the second core layer 30 in the third direction Dc. The first propagation portion 21 is connected to the first tapered portion 22 on the emission direction Da1 side.

The first tapered portion 22 is a portion that optically couples the first core layer 20 to the second core layer 30, and is a portion that causes the laser light propagated to the first propagation portion 21 to transition to the second core layer 30. The first tapered portion 22 is disposed on an end portion of the first core layer 20 on the emission direction Da1 side in the first direction Da.

A size of the first tapered portion 22 in the second direction Db from the end portion on the emission reverse direction Da2 side in the first direction Da to the end portion on the emission direction Da1 side is constant. In contrast, a size of the first tapered portion 22 in the third direction Dc from the end portion on the emission reverse direction Da2 side in the first direction Da to the end portion on the emission direction Da1 side gradually decreases along the emission direction Da1. Specifically, for the size of the first tapered portion 22 in the third direction Dc, the size of the end portion on the emission reverse direction Da2 side is 2.0 μm, and the size of the end portion on the emission direction Da1 side is 0.2 μm. Therefore, for the first tapered portion 22, a difference between the size of the end portion on the emission direction Da1 side in the third direction Dc and the size of the end portion on the emission reverse direction Da2 side in the third direction Dc is 1.8 μm.

The size of the first tapered portion 22 in the third direction Dc from the end portion on the emission reverse direction Da2 side in the first direction Da to the end portion on the emission direction Da1 side continuously decreases. A size of the first tapered portion 22 in the first direction Da is 1000 μm. Therefore, for the first tapered portion 22, an absolute value of variation in the third direction Dc per 1 μm in the emission direction Da1 is 1.8 nm.

For the first tapered portion 22, the size of the end portion, which is on the emission direction Da1 side, in the third direction Dc is the smallest size that can be minimized in a manufacturing process to be used.

At least a part of the first tapered portion 22 is provided at a position overlapping the second core layer 30 in the third direction Dc. In the present embodiment, the entire first tapered portion 22 is provided at a position overlapping the second core layer 30 in the third direction Dc.

As shown in FIGS. 1 and 3, the second core layer 30 is spaced apart from the first core layer 20 on the one-side third direction Dc1 side of the first core layer 20 on the first cladding layer 11, and extends in the first direction Da. Specifically, the second core layer 30 is spaced apart from the first core layer 20 such that an interval between a center of the second core layer 30 in the third direction Dc and a center of the first core layer 20 in the third direction Dc is 2.0 μm. The second core layer 30 is made of silicon nitride which is a material same as the first core layer 20. The second core layer 30 is spaced apart from the end portion of the spot size converter 1 in the emission reverse direction Da2 with respect to the first core layer 20.

A size of the second core layer 30 in the second direction Db is larger than the size of the first core layer 20 in the second direction Db. Specifically, the size of the second core layer 30 in the second direction Db is 0.30 μm. The second core layer 30 protrudes respectively toward the stacking forward direction Db1 and the stacking reverse direction Db2 from the first core layer 20. Specifically, the size of the second core layer 30 in the second direction Db is 0.30 μm, and the second core layer 30 protrudes respectively by 0.15 μm toward the stacking forward direction Db1 and the stacking reverse direction Db2 from a center of the first core layer 20 in the second direction Db.

As shown in FIG. 3, the second core layer 30 has a second core surface 31 that is a surface on the first cladding layer 11 side in the second direction Db. The second core surface 31 is a surface in contact with the first cladding layer 11 on which the second core layer 30 is provided. The second core surface 31 does not overlap the first core surface 25 in the second direction Db, and is positioned on the stacking reverse direction Db2 side with respect to the first core surface 25.

As shown in FIG. 1, the second core layer 30 has a second emission reverse side surface 32 on an end portion in the emission reverse direction Da2 and a second emission side surface 33 on an end portion in the emission direction Da1. The second emission reverse side surface 32 is a surface closer to the end portion of the spot size converter 1 in the emission reverse direction Da2 than the second emission side surface 33. The second emission reverse side surface 32 is positioned on the emission reverse direction Da2 side with respect to the first emission side surface 24. That is, the second emission reverse side surface 32 is disposed at a position closer to the end portion of the spot size converter 1 in the emission reverse direction Da2 than the first emission side surface 24. The second emission side surface 33 is a surface opposite to the second emission reverse side surface 32 on the second core layer 30. The second emission side surface 33 is positioned on the end portion of the spot size converter 1 in the emission direction Da1.

The second core layer 30 includes a second tapered portion 34 and a second propagation portion 35. The second tapered portion 34 and the second propagation portion 35 are provided in this order along the emission direction Da1.

The second tapered portion 34 is a portion that optically couples the first core layer 20 and the second core layer 30, and is a portion to which the laser light propagated from the first propagation portion 21 to the first tapered portion 22 transitions. The second tapered portion 34 is disposed on an end portion of the second core layer 30 on the emission reverse direction Da2 side in the first direction Da.

A size of the second tapered portion 34 in the second direction Db from the end portion on the emission reverse direction Da2 side in the first direction Da to the end portion on the emission direction Da1 side is constant. In contrast, a size of the second tapered portion 34 in the third direction Dc from the end portion on the emission reverse direction Da2 side in the first direction Da to the end portion on the emission direction Da1 side gradually increases along the emission direction Da1. The size of the second tapered portion 34 in the third direction Dc on the end portion in the emission reverse direction Da2 is smaller than the size of the first tapered portion 22 in the third direction Dc on the end portion in the emission reverse direction Da2. The size of the second tapered portion 34 in the third direction Dc on the end portion in the emission direction Da1 is larger than the size of the first tapered portion 22 in the third direction Dc on the end portion in the emission direction Da1. A size of the second tapered portion 34 in the second direction Db on the end portion in the emission reverse direction Da2 is larger than the size in the third direction Dc.

Specifically, for the size of the second tapered portion 34 in the third direction Dc, the size of the end portion on the emission reverse direction Da2 side is 0.2 μm, and the size of the end portion on the emission direction Da1 side is 1.0 μm. Therefore, for the second tapered portion 34, a difference between the size of the end portion on the emission direction Da1 side in the third direction Dc and the size of the end portion on the emission reverse direction Da2 side in the third direction Dc is 0.8 μm.

The size of the second tapered portion 34 in the third direction Dc from the end portion on the emission reverse direction Da2 side in the first direction Da to the end portion on the emission direction Da1 side continuously increases. A size of the second tapered portion 34 in the first direction Da is 1000 μm. Therefore, for the second tapered portion 34, an absolute value of variation in the third direction Dc per 1 μm in the emission direction Da1 is 0.8 nm.

Accordingly, the absolute value of the variation of the second tapered portion 34 in the third direction Dc per unit length in the emission direction Da1 is smaller than the absolute value of the variation of the first tapered portion 22 in the third direction Dc per unit length in the emission direction Da1. In other words, the absolute value of the variation of the first tapered portion 22 in the third direction Dc per unit length in the emission direction Da1 is larger than the absolute value of the variation of the second tapered portion 34 in the third direction Dc per unit length in the emission direction Da1. In the present embodiment, the absolute value of the variation of the first tapered portion 22 in the third direction Dc per unit length in the emission direction Da1 is twice or more the absolute value of the variation of the second tapered portion 34 in the third direction Dc per unit length in the emission direction Da1.

As long as, the absolute value of the variation of the first tapered portion 22 in the third direction Dc per unit length in the emission direction Da1 is larger than the absolute value of the variation of the second tapered portion 34 in the third direction Dc per unit length in the emission direction Da1, the size is not limited. For example, the absolute value of the variation of the first tapered portion 22 in the third direction Dc per unit length in the emission direction Da1 may be smaller than twice the absolute value of the variation of the second tapered portion 34 in the third direction Dc per unit length in the emission direction Da1.

For the second tapered portion 34, the size of the end portion, which is on the emission reverse direction Da2 side, in the third direction Dc is the smallest size that can be minimized in the manufacturing process to be used.

At least a part of the second tapered portion 34 is provided at a position overlapping the first tapered portion 22 on the first core layer 20 in the third direction Dc. In the present embodiment, the entire second tapered portion 34 is provided at a position overlapping the first tapered portion 22 in the third direction Dc. That is, the size of the second tapered portion 34 in the first direction Da is equal to the size of the first tapered portion 22 in the first direction Da.

Therefore, a position of the end portion of the first tapered portion 22, which is on the emission reverse direction Da2 side, in the first direction Da matches a position of the end portion of the second tapered portion 34, which is on the emission reverse direction Da2 side, in the first direction Da. A position of the end portion of the first tapered portion 22, which is on the emission direction Da1 side, in the first direction Da matches a position of the end portion of the second tapered portion 34, which is on the emission direction Da1 side, in the first direction Da. That is, the size of the first tapered portion 22 in the first direction Da is equal to the size of the second tapered portion 34 in the first direction Da.

As described above, in the spot size converter 1, while the size of the first tapered portion 22 in the third direction Dc gradually decreases along the emission direction Da1, the size of the second tapered portion 34 in the third direction Dc gradually increases along the emission direction Da1. The first tapered portion 22 and the second tapered portion 34 function as waveguide paths in the spot size converter 1.

Therefore, in the spot size converter 1, a cross-sectional area of the waveguide path orthogonal to the emission direction Da1 at the first tapered portion 22 functioning as the waveguide path gradually decreases along the emission direction Da1. In contrast, in the spot size converter 1, a cross-sectional area of the waveguide path orthogonal to the emission direction Da1 at the second tapered portion 34 functioning as the waveguide path gradually increases along the emission direction Da1.

Accordingly, among the waveguide paths in the spot size converter 1, a cross-sectional area of the waveguide path orthogonal to the emission direction Da1 at a portion formed by the first tapered portion 22 and the second tapered portion 34 is less likely to change along the emission direction Da1. The second tapered portion 34 is connected to the second propagation portion 35 on the emission direction Da1 side.

The second propagation portion 35 is a portion optically coupled to the circuit waveguide path CW, and guides the laser light propagated from the optical fiber waveguide path FW to the circuit waveguide path CW. A size of the second propagation portion 35 in the second direction Db and a size of the second propagation portion 35 in the third direction Dc from a one side end portion to the other side end portion in the first direction Da are constant. Specifically, the size of the second propagation portion 35 in the second direction Db is 0.30 μm and the size of the second propagation portion 35 in the third direction Dc is 1.0 μm. The second propagation portion 35 is provided on the emission direction Da1 side with respect to the first core layer 20. That is, the second propagation portion 35 is provided at a position not overlapping the first core layer 20 in the third direction Dc.

In the manufacturing of the spot size converter 1 according to the present embodiment, first, the first cladding layer 11 is formed on a substrate (not shown).

Then, the second core layer 30 is formed on the first cladding layer 11 by patterning, and then the second cladding layer 12 is formed on the second core layer 30 and a portion of the first cladding layer 11 on which the second core layer 30 is not formed. Then, the second cladding layer 12 formed on the second core layer 30 is removed by, for example, chemical mechanical polish (CMP).

Thereafter, the first core layer 20 is formed on the second cladding layer 12 by patterning. Then, the third cladding layer 13 is formed on the first core layer 20, the second core layer 30, and portions of the second cladding layer 12 on which the first core layer 20 and the second core layer 30 are not formed. Accordingly, the first core layer 20 and the second core layer 30 are covered with the third cladding layer 13.

Thereafter, unnecessary portions of the third cladding layer 13 formed on the first core layer 20 and the second core layer 30 are removed by, for example, CMP. Accordingly, the spot size converter 1 in which the first cladding layer 11 to the third cladding layer 13, the first core layer 20, and the second core layer 30 are provided on the substrate (not shown) is manufactured.

Next, an operation of the spot size converter 1 according to the present embodiment will be described. In the spot size converter 1 according to the present embodiment, when a laser light is propagated from the optical fiber waveguide path FW to the first propagation portion 21 of the first core layer 20, the laser light is propagated through the first propagation portion 21 along the emission direction Da1, and is propagated from the first propagation portion 21 to the first tapered portion 22. The laser light propagated to the first tapered portion 22 is propagated through the first tapered portion 22 along the emission direction Da1.

The size of the first tapered portion 22 in the third direction Dc decreases along the emission direction Da1. Therefore, in the first tapered portion 22, optical confinement when the laser light is propagated is gradually weakened along the emission direction Da1. That is, an optical confinement coefficient of the first tapered portion 22 gradually decreases along the emission direction Da1. Therefore, the laser light propagated through the first tapered portion 22 gradually transitions to the second tapered portion 34.

The laser light that has transitioned to the second tapered portion 34 is propagated through the second tapered portion 34 along the emission direction Da1, and is propagated from the second tapered portion 34 to the second propagation portion 35. The laser light propagated to the second propagation portion 35 is propagated through the second propagation portion 35 along the emission direction Da1 and is propagated to the circuit waveguide path CW.

The first propagation portion 21 in the first core layer 20 through which the laser light is propagated from the optical fiber waveguide path FW is formed in a thin flat shape in which the size in the second direction Db is significantly smaller than the size in the third direction Dc. Therefore, the first core layer 20 can expand an electric field intensity distribution of the optical fiber waveguide path FW in the third direction Dc, and can sufficiently secure the optical confinement coefficient in the third direction Dc. Accordingly, in the first core layer 20, the electric field intensity distribution in the third direction Dc can be expanded to the same extent as the size of the first core layer 20 in the third direction Dc.

In the first core layer 20 having a thin flat shape, an optical confinement coefficient in the second direction Db is smaller than the optical confinement coefficient in the third direction Dc. Therefore, in the first core layer 20, an electric field intensity distribution in the second direction Db is expanded. Accordingly, in the first core layer 20, the electric field intensity distribution in the second direction Db can be wider than the size of the first core layer 20 in the second direction Db.

In the second propagation portion 35 that propagates the laser light to the circuit waveguide path CW in the second core layer 30, the size in the second direction Db is larger than the size of the first propagation portion 21 in the second direction Db. Therefore, an optical confinement coefficient in the second direction Db is larger than that of the first propagation portion 21. Accordingly, in the second core layer 30, electric field intensity distributions in the second direction Db and the third direction Dc are narrowed.

Accordingly, the spot size converter 1 efficiently couples the optical fiber waveguide path FW and the circuit waveguide path CW having different cross-sectional areas orthogonal to the emission direction Da1.

In the spot size converter 1, when the cross-sectional area of the waveguide path of the spot size converter 1 rapidly changes, the electric field intensity distribution of the laser light rapidly changes when the laser light passes through the portion in which the cross-sectional area rapidly changes. When the electric field intensity distribution rapidly changes, loss occurs when the light is propagated in the spot size converter 1, and light transmission efficiency in the spot size converter 1 decreases. The loss causes deterioration in transmission efficiency when the light is propagated through the waveguide path in the spot size converter 1, and causes deterioration in net coupling efficiency when the spot size converter 1 couples the optical fiber waveguide path FW and the circuit waveguide path CW.

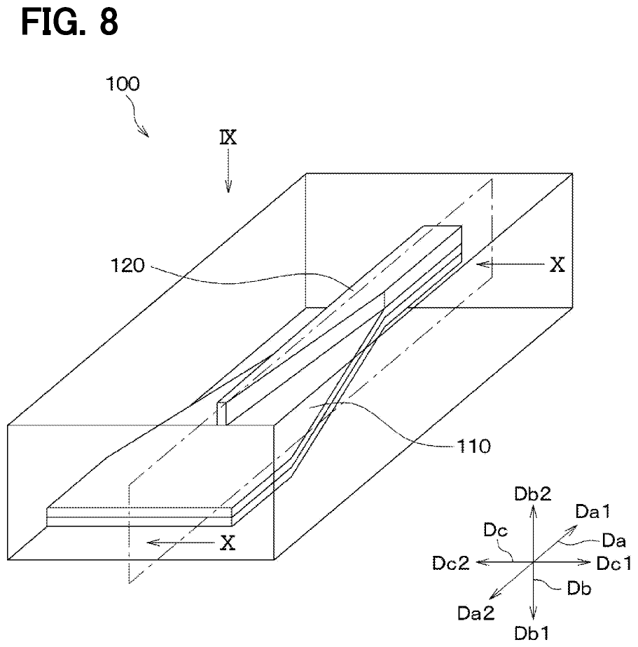

In order to describe the electric field intensity distribution in the spot size converter 1 according to the present embodiment, first, an electric field intensity distribution in a comparative converter 100 as a comparative example will be described with reference to FIGS. 8 to 13.

As shown in FIGS. 8 to 10, the comparative converter 100 includes a lower core layer 110 and an upper core layer 120 extending along the first direction Da and functioning as a waveguide path.

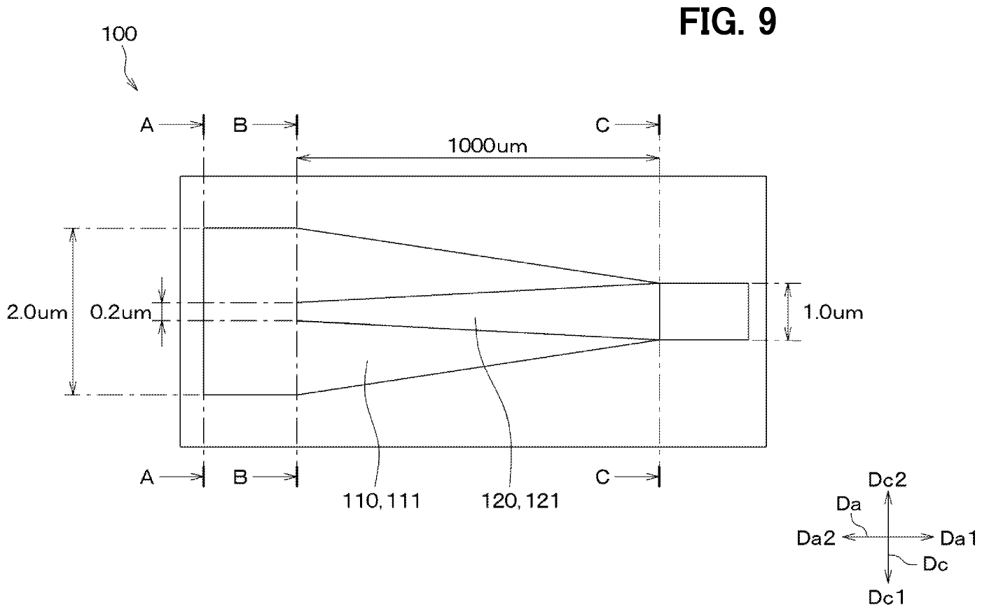

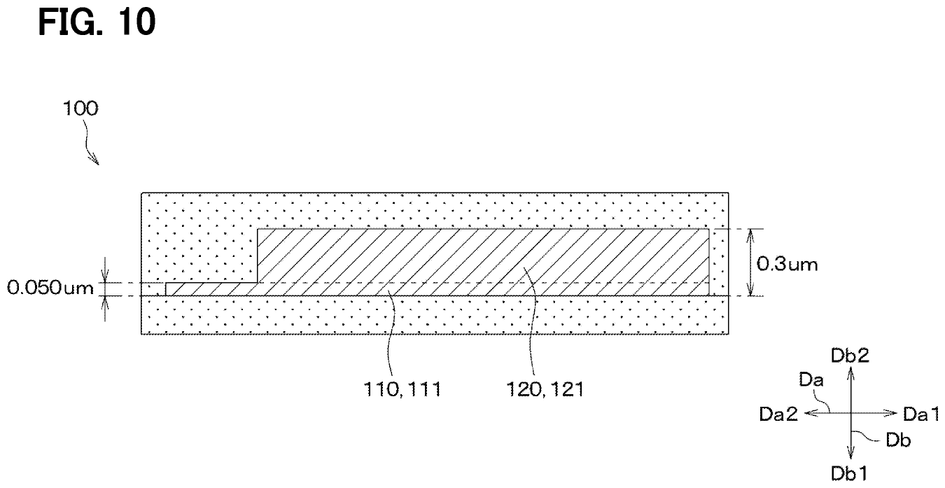

As shown in FIGS. 9 and 10, the lower core layer 110 has a thin flat shape, and includes a lower tapered portion 111 in which a size thereof in the third direction Dc decreases along the emission direction Da1. A size of the lower tapered portion 111 in the second direction Db is 0.050 μm, and a size of an end portion on the emission reverse direction Da2 side in the third direction Dc is 2.0 μm. A size of the lower tapered portion 111 in the first direction Da is 1000 μm.

As shown in FIGS. 9 and 10, the upper core layer 120 is provided on the lower core layer 110, and includes an upper tapered portion 121 in which a size thereof in the third direction Dc increases along the emission direction Da1.

A size of the upper tapered portion 121 in the second direction Db is 0.25 μm. For the upper tapered portion 121, a size of an end portion, which is on the emission reverse direction Da2 side, in the third direction Dc is 0.2 μm which is the smallest size that can be minimized in the manufacturing process. For the upper tapered portion 121, a size of an end portion, which is on the emission direction Da1 side, in the third direction Dc is 1.0 μm. The upper tapered portion 121 has a size of 1000 μm in the first direction Da, and overlaps the lower tapered portion 111 in the first direction Da.

When the comparative converter 100 configured as described above is provided between the optical fiber waveguide path FW and the circuit waveguide path CW and the laser light emitted from the optical fiber waveguide path FW is guided to the circuit waveguide path CW, the electric field intensity distribution is examined. In the comparative converter 100 configured as described above, when the laser light emitted from the optical fiber waveguide path FW is propagated to the lower tapered portion 111 of the lower core layer 110, the laser light is propagated through the lower tapered portion 111 along the emission direction Da1.

The size of the lower tapered portion 111 in the third direction Dc decreases along the emission direction Da1. Therefore, in the lower tapered portion 111, optical confinement when the laser light is propagated is gradually weakened along the emission direction Da1. Therefore, the laser light propagated through the lower tapered portion 111 gradually transitions to the upper tapered portion 121. The laser light that has transitioned to the upper tapered portion 121 is propagated through the upper tapered portion 121 along the emission direction Da1, and is propagated to the circuit waveguide path CW.

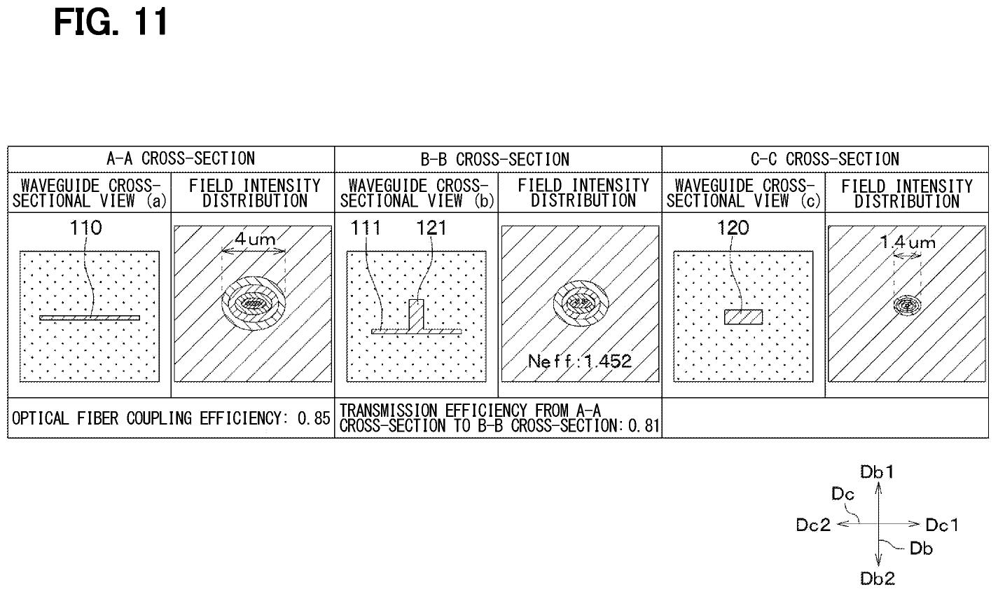

In the comparative converter 100, in the waveguide path formed by the lower core layer 110 and the upper core layer 120, a cross-sectional shape orthogonal to the emission direction Da1 immediately before the laser light passes through an end portion of the upper core layer 120 on the emission reverse direction Da2 side is a shape of the lower core layer 110. Specifically, as shown in FIG. 11, the cross-sectional shape is a thin flat shape having a size of 0.050 μm in the second direction Db and a size of 2.0 μm in the third direction Dc.

Regarding this, the cross-sectional shape of the waveguide path orthogonal to the emission direction Da1 immediately after the laser light passes through the end portion of the upper core layer 120 on the emission reverse direction Da2 side is a cross-sectional shape in which the upper core layer 120 is stacked on the lower core layer 110 as shown in FIG. 11. Specifically, the cross-sectional shape is a shape in which the rectangular upper core layer 120 having a size of 0.25 μm in the second direction Db and a size of 0.2 μm in the third direction Dc is stacked on the lower core layer 110 having a thin flat shape.

Among cross-sectional views of the waveguide path shown in FIG. 11, a waveguide path cross-sectional view a is a cross-sectional view taken along a line A-A of the end portion of the lower core layer 110 on the emission reverse direction Da2 side shown in FIG. 9, and a waveguide path cross-sectional view b is a cross-sectional view taken along a line B-B of the end portion of the upper core layer 120 on the emission reverse direction Da2 side. A waveguide path cross-sectional view c is a cross-sectional view taken along a line C-C of the end portion of the upper tapered portion 121 on the emission direction Da1 side.

Accordingly, for the cross-sectional shape of the waveguide path orthogonal to the emission direction Da1 in the comparative converter 100, a shape immediately after the laser light passes through the end portion of the upper core layer 120 on the emission reverse direction Da2 side as compared with immediately before the laser light passes through the end portion is a shape in which the rectangular upper core layer 120 protrudes on the thin flat lower core layer 110. Accordingly, immediately after the laser light passes through the end portion of the upper core layer 120 on the emission reverse direction Da2 side, optical confinement in the second direction Db rapidly changes. That is, immediately after the laser light passes through the end portion of the upper core layer 120 on the emission reverse direction Da2 side, an optical confinement coefficient in the second direction Db rapidly changes.

When the optical confinement coefficient of the waveguide path rapidly changes in the comparative converter 100, as shown in FIG. 11, the electric field intensity distribution of the laser light rapidly changes when the laser light passes through the end portion of the upper core layer 120 on the emission reverse direction Da2 side.

When the electric field intensity distribution changes relatively greatly, loss occurs when the light is propagated in the comparative converter 100, and light transmission efficiency decreases. In the comparative converter 100, a light transmittance is reduced to 0.81 when the light is propagated from the lower core layer 110 to the end portion of the upper core layer 120 on the emission reverse direction Da2 side.

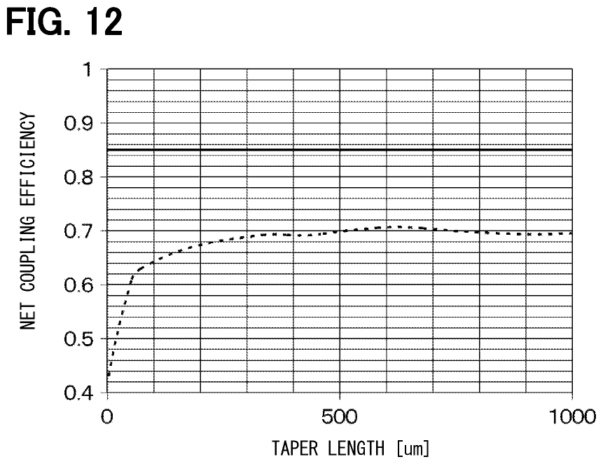

According to intensive studies by the inventors, in the comparative converter 100, when an input of the laser light propagated to the lower core layer 110 is set to 1, coupling efficiency at a position shown in the cross-sectional view taken along the line A-A is 0.85 as shown in FIG. 12. Regarding this, as shown in FIG. 12, coupling efficiency at a position shown in the cross-sectional view taken along the line C-C can be increased, when a length of the upper tapered portion 121 in the first direction Da is a taper length, as the taper length is increased until the taper length is about 500 μm. However, when the taper length is 500 μm or more, the coupling efficiency is a saturated value, and the value cannot be increased from the saturated value. The value of the saturated coupling efficiency is 0.69.

A solid line shown in FIG. 12 indicates coupling efficiency at a position of the end portion of the lower tapered portion 111 on the emission reverse direction Da2 side, and a dashed line indicates coupling efficiency at a position of the end portion of the lower tapered portion 111 on the emission direction Da1 side.

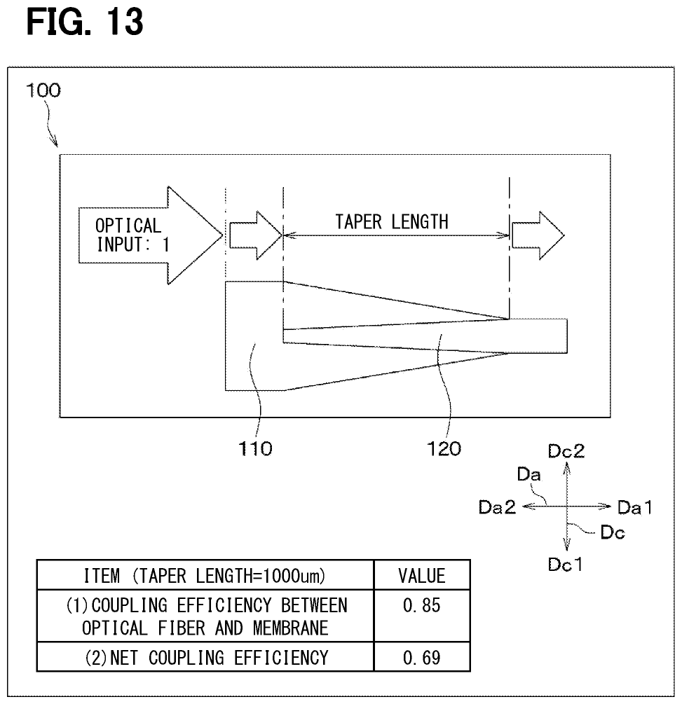

The coupling efficiency when the comparative converter 100 couples the optical fiber waveguide path FW and the circuit waveguide path CW is the coupling efficiency at the position shown in the cross-sectional view taken along the line C-C. The coupling efficiency is a value obtained by multiplying a value of the light transmittance, when the light is propagated from the lower core layer 110 to the end portion of the upper core layer 120 on the emission reverse direction Da2 side, by the value of the coupling efficiency at the position shown in the cross-sectional view taken along the line C-C. Specifically, as shown in FIG. 13, a value of the net coupling efficiency, which is an actual coupling efficiency when the comparative converter 100 couples the optical fiber waveguide path FW and the circuit waveguide path CW, is 0.69, which is a value obtained by multiplying 0.81 by 0.85.

As described above, in the comparative converter 100 in which the optical confinement rapidly changes, the electric field intensity distribution in the waveguide path greatly changes, so that the light transmittance in the comparative converter 100 decreases and the net coupling efficiency rapidly decreases.

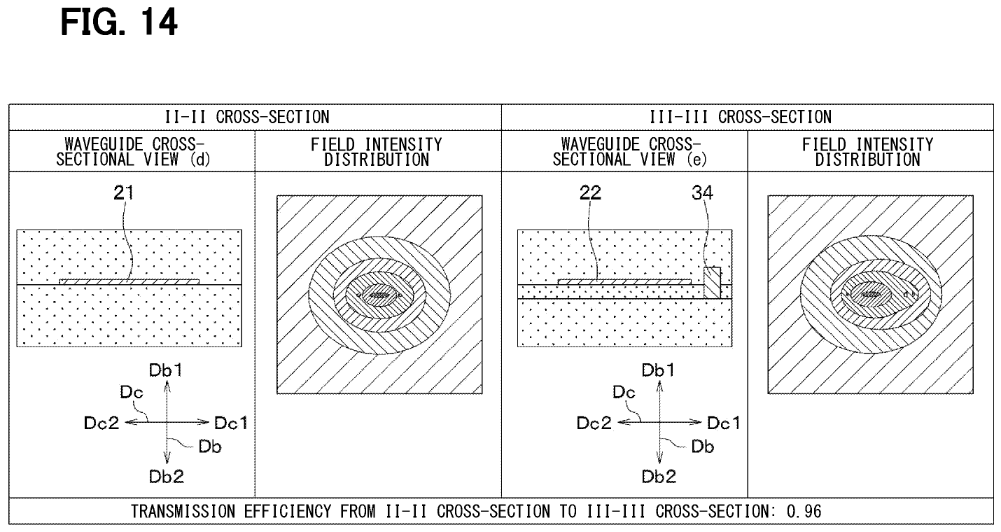

Next, the electric field intensity distribution in the spot size converter 1 according to the present embodiment will be described with reference to FIGS. 14 to 16.

As described above, the first core layer 20 according to the present embodiment is formed in a thin flat shape in which the size in the second direction Db is significantly smaller than the size in the third direction Dc. Therefore, in the spot size converter 1, at the portion on which the first core layer 20 is disposed, the electric field intensity distribution in the third direction Dc can be expanded, and the optical confinement coefficient in the third direction Dc can be sufficiently secured. In other words, the first core layer 20 can confine the expansion of the laser light in the third direction Dc.

In the first core layer 20 having a thin flat shape, the optical confinement coefficient in the second direction Db is much smaller than the optical confinement coefficient in the third direction Dc. Specifically, in the spot size converter 1 according to the present embodiment, the value of the optical confinement coefficient in the second direction Db is 0.01 while the value of the optical confinement coefficient in the third direction Dc is 0.39. As described above, since the first core layer 20 is very small in the optical confinement in the second direction Db, the electric field intensity distribution in the first core layer 20 in the second direction Db can be expanded.

With respect to such a first core layer 20, the second core layer 30 according to the present embodiment is spaced apart from the first core layer 20 on the one-side third direction Dc1 side of the first core layer 20. That is, the second core layer 30 is spaced apart from the first core layer 20 in the third direction Dc in which a sufficient optical confinement coefficient is secured in the first core layer 20.

Therefore, in the spot size converter 1, in the waveguide path formed by the first core layer 20 and the second core layer 30, the cross-sectional shape of the waveguide path orthogonal to the emission direction Da1 immediately before the laser light passes through the end portion of the second core layer 30 on the emission reverse direction Da2 side is a shape of the first core layer 20. Specifically, as shown in FIG. 14, the cross-sectional shape is a thin flat shape having a size of 0.050 μm in the second direction Db and a size of 2.0 μm in the third direction Dc. Regarding this, the cross-sectional shape of the waveguide path orthogonal to the emission direction Da1 immediately after the laser light passes through the end portion of the second core layer 30 on the emission reverse direction Da2 side is a cross-sectional shape in which the first core layer 20 and the second core layer 30 are disposed in the third direction Dc to be spaced apart from each other. Specifically, the cross-sectional shape is a shape in which the rectangular second core layer 30 having a size of 0.30 μm in the second direction Db and a size of 0.20 μm in the third direction Dc is disposed on and spaced apart from the thin flat first core layer 20.

Among cross-sectional views of the waveguide path shown in FIG. 14, a waveguide path cross-sectional view d is a cross-sectional view taken along a line II-II of the first propagation portion 21 of the first core layer 20 shown in FIG. 1, and a waveguide path cross-sectional view e is a cross-sectional view taken along a line III-III of the end portion of the second core layer 30 on the emission reverse direction Da2 side.

In the spot size converter 1 configured as described above, the cross-sectional shape of the waveguide path immediately after the laser light passes through the end portion of the second core layer 30 on the emission reverse direction Da2 side as compared with immediately before the laser light passes through the end portion is a shape obtained by increasing the cross-sectional shape of the second core layer 30 in the cross-sectional shape of the first core layer 20. However, the optical confinement coefficient of the first core layer 20 in the third direction Dc can be sufficiently secured, and the first core layer 20 can confine the expansion of the laser light in the third direction Dc. Therefore, immediately after the laser light passes through the end portion of the second core layer 30 in the emission reverse direction Da2, a change in the optical confinement in the third direction Dc can be limited. That is, immediately after the laser light passes through the end portion of the second core layer 30 in the emission reverse direction Da2, a rapid change in the optical confinement coefficient in the third direction Dc can be limited.

Therefore, as shown in FIG. 14, the spot size converter 1 can reduce a change in the electric field intensity distribution of the laser light when the laser light passes through the end portion of the second core layer 30 in the emission reverse direction Da2 as compared with the comparative converter 100.

By reducing the change in the electric field intensity distribution, the loss occurs when the light is propagated can be reduced, and a decrease amount when the light transmission efficiency decreases can be reduced, as compared with the comparative converter 100. In the spot size converter 1 according to the present embodiment, the light transmittance is 0.96 when the light is propagated from the first core layer 20 to the end portion of the second core layer 30 on the emission reverse direction Da2 side.

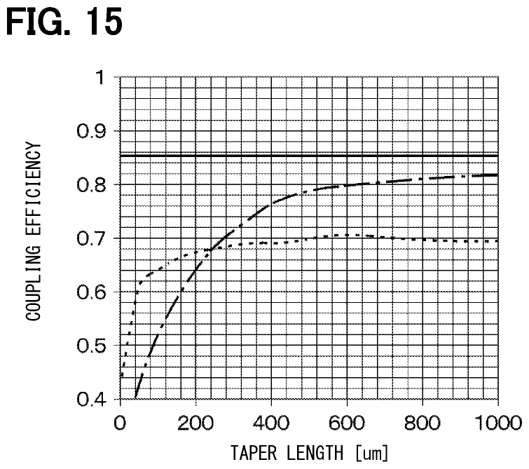

In the spot size converter 1, when the input of the laser light propagated to the first core layer 20 is set to 1, the coupling efficiency from the end portion of the first core layer 20 on the emission reverse direction Da2 side to the end portion on the emission direction Da1 side is 0.85 as shown in FIG. 15 similarly to the comparative converter 100. Regarding this, as shown in FIG. 15, the coupling efficiency from the end portion of the second core layer 30 on the emission reverse direction Da2 side to the end portion on the emission direction Da1 side can be increased as a taper length which is a length of the second tapered portion 34 in the first direction Da is increased.

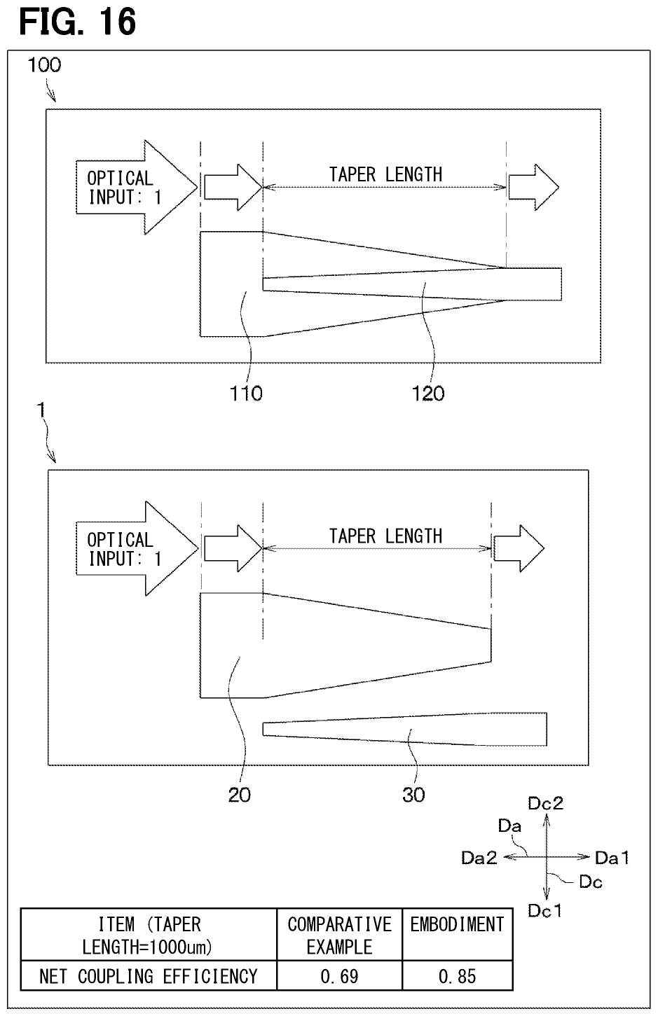

The value of the net coupling efficiency of the spot size converter 1 according to the present embodiment is a value obtained by multiplying the value of the light transmittance, when the light is propagated from the first core layer 20 to the end portion of the second core layer 30 on the emission reverse direction Da2 side, by the value of the coupling efficiency between the first core layer 20 and the second core layer 30. The value of the net coupling efficiency of the spot size converter 1 is 0.85 as shown in FIG. 16.

A solid line shown in FIG. 15 indicates the coupling efficiency at the position of the end portion of the lower tapered portion 111 on the emission reverse direction Da2 side. A dashed line indicates the coupling efficiency at the position of the end portion of the lower tapered portion 111 on the emission direction Da1 side in the comparative converter 100. A one-dot chain line indicates the coupling efficiency at the position of the end portion of the lower tapered portion 111 on the emission direction Da1 side in the spot size converter 1 according to the present embodiment.

As described above, the spot size converter 1 according to the present embodiment can improve the net coupling efficiency as compared with the comparative converter 100 formed by stacking the lower core layer 110 and the upper core layer 120 in the second direction Db.

As described above, the spot size converter 1 according to the present embodiment includes the first core layer 20 and the second core layer 30 spaced apart from the first core layer 20 in the one-side third direction Dc1 on the first core layer 20. The first core layer 20 has a flat shape in which the size in the second direction Db is smaller than the size in the third direction Dc, and includes the first tapered portion 22 in which the size thereof in the third direction Dc decreases along the emission direction Da1 on the end portion in the emission direction Da1. The second core layer 30 is formed such that the size in the second direction Db is larger than the size of the first core layer 20 in the second direction Db, and includes the second tapered portion 34 in which the size in the third direction Dc increases along the emission direction Da1 on the end portion in the emission reverse direction Da2. The second tapered portion 34 is disposed at a position overlapping the first tapered portion 22 in the third direction Dc.

In the spot size converter 1 configured as described above, the laser light transitions from the first tapered portion 22 positioned on the end portion of the first core layer 20 in the emission direction Da1 to the second tapered portion 34 positioned on the end portion of the second core layer 30 in the emission reverse direction Da2.

The first core layer 20 can confine the expansion of the laser light in the third direction Dc in the end portion of the first core layer 20 in the emission direction Da1. Therefore, in a configuration in which the second core layer 30 is spaced apart from the first core layer 20 in the one-side third direction Dc1 in the end portion of the first core layer 20 in the emission direction Da1, the change in the optical confinement in the third direction Dc can be limited.

Accordingly, the spot size converter 1 can limit the change in the electric field intensity distribution of the laser light when the laser light passes through the end portion of the second core layer 30 on the emission reverse direction Da2 side. By reducing the change in the electric field intensity distribution, the loss occurs when the light is propagated can be reduced, and deterioration in light transmission efficiency can be reduced. Accordingly, it is possible to improve the coupling efficiency of the spot size converter 1 when coupling two waveguide paths having different cross-sectional areas orthogonal to the emission direction Da1 of the laser light.

According to the above embodiment, the following effects can be obtained.

(1) In the above embodiment, the second core layer 30 is formed such that the size in the third direction Dc on the end portion in the emission reverse direction Da2 is smaller than the size in the second direction Db.

Accordingly, immediately before and immediately after the laser light passes through the end portion of the second tapered portion 34 on the emission reverse direction Da2 side, the change in the cross-sectional shape of the waveguide path orthogonal to the emission direction Da1 in the spot size converter 1 can be limited, as compared with a case where such a configuration is not formed.

Therefore, the change in the electric field intensity distribution of the laser light due to the rapid change in the cross-sectional area of the waveguide path in the spot size converter 1 can be limited. Accordingly, the deterioration of the transmission efficiency when the laser light is propagated through the waveguide path in the spot size converter 1 can be reduced. Accordingly, it is possible to further improve the coupling efficiency of the spot size converter 1 when coupling two waveguide paths having different cross-sectional areas orthogonal to the emission direction Da1 of the laser light.

(2) In the above embodiment, the position of the end portion of the first tapered portion 22, which is on the emission reverse direction Da2 side, in the first direction Da matches the position of the end portion of the second tapered portion 34, which is on the emission reverse direction Da2 side, in the first direction Da.

Accordingly, immediately before and immediately after the laser light passes through the end portion of the second tapered portion 34 on the emission reverse direction Da2 side, the change in the cross-sectional shape of the waveguide path orthogonal to the emission direction Da1 in the spot size converter 1 can be limited, as compared with a case where such a configuration is not formed.

Therefore, the change in the electric field intensity distribution of the laser light due to the rapid change in the cross-sectional area of the waveguide path in the spot size converter 1 can be limited. Accordingly, the deterioration of the transmission efficiency when the laser light is propagated through the waveguide path in the spot size converter 1 can be reduced. Accordingly, it is possible to further improve the coupling efficiency of the spot size converter 1 when coupling two waveguide paths having different cross-sectional areas orthogonal to the emission direction Da1 of the laser light.

(3) In the above embodiment, the position of the end portion of the first tapered portion 22 in the emission direction Da1 in the first direction Da matches the position of the end portion of the second tapered portion 34 in the emission direction Da1 in the first direction Da.

Accordingly, immediately before and immediately after the laser light passes through the end portion of the second tapered portion 34 on the emission direction Da1 side, the change in the cross-sectional shape of the waveguide path orthogonal to the emission direction Da1 in the spot size converter 1 can be limited, as compared with a case where such a configuration is not formed.

Therefore, the change in the electric field intensity distribution of the laser light due to the rapid change in the cross-sectional area of the waveguide path in the spot size converter 1 can be limited. Accordingly, the deterioration of the transmission efficiency when the laser light is propagated through the waveguide path in the spot size converter 1 can be reduced. Accordingly, it is possible to further improve the coupling efficiency of the spot size converter 1 when coupling two waveguide paths having different cross-sectional areas orthogonal to the emission direction Da1 of the laser light.

(4) In the above embodiment, the first core layer 20 and the second core layer 30 are made of silicon nitride.

Accordingly, a refractive index of the light of the first core layer 20 and the second core layer 30 can be reduced compared to the case where the first core layer 20 and the second core layer 30 are made of, for example, silicon. Therefore, in the first core layer 20, the optical confinement coefficient in the second direction Db can be small; and the electric field intensity distribution in the second direction Db can be easily expanded.

### Second Embodiment

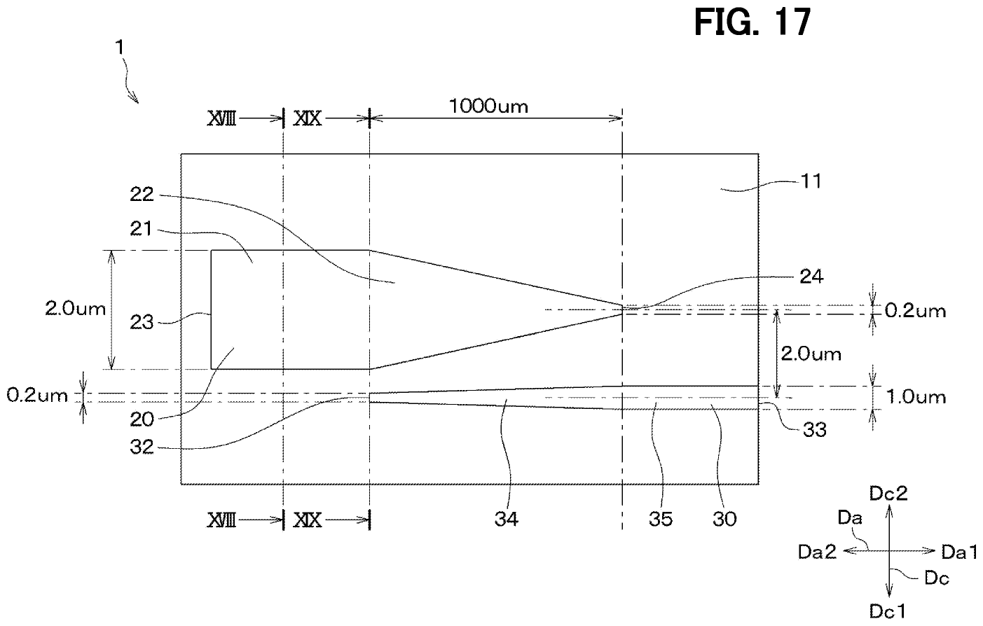

Next, a second embodiment will be described with reference to FIGS. 17 to 20. The present embodiment is different from the first embodiment in a positional relationship between a first core layer 20 and a second core layer 30 in a second direction Db. The other configuration is the same as that of the first embodiment. Therefore, in the present embodiment, portions different from the first embodiment will be mainly described, and description of portions similar to the first embodiment may be omitted.

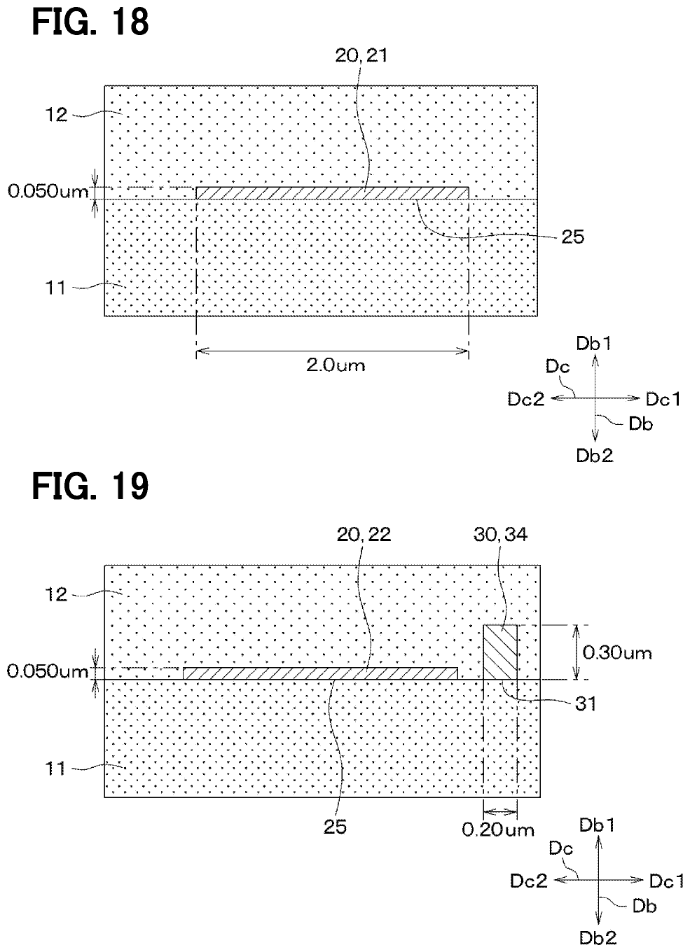

In a spot size converter 1 according to the present embodiment, as shown in FIGS. 17 to 19, a third cladding layer 13 is not provided as compared with the first embodiment. As shown in FIGS. 18 and 19, the spot size converter 1 according to the present embodiment is different from the first embodiment in that the first core layer 20 is provided on a first cladding layer 11. The first core layer 20 is provided on the first cladding layer 11 on which the second core layer 30 is provided. In other words, the first cladding layer 11 on which the first core layer 20 is provided is the same cladding layer as the first cladding layer 11 on which the second core layer 30 is provided. Therefore, a second core surface 31 according to the present embodiment overlaps a first core surface 25 in the second direction Db.

In manufacturing of the spot size converter 1 according to the present embodiment, first, the first cladding layer 11 is formed on a substrate (not shown). Then, the first core layer 20 and the second core layer 30 are formed on the first cladding layer 11 by patterning. Thereafter, a second cladding layer 12 is formed on the first core layer 20, on the second core layer 30, and on portions of the first cladding layer 11 on which the first core layer 20 and the second core layer 30 are not formed. Accordingly, the first core layer 20 and the second core layer 30 are covered with the second cladding layer 12.

Then, unnecessary portions of the second cladding layer 12 formed on the first core layer 20 and the second core layer 30 are removed by, for example, CMP. Accordingly, the spot size converter 1 in which the first cladding layer 11, the second cladding layer 12, the first core layer 20, and the second core layer 30 are provided on the substrate (not shown) is manufactured.

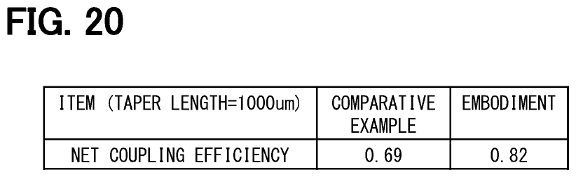

In the spot size converter 1 configured as described above, a light transmittance when a light is propagated from the first core layer 20 to an end portion of the second core layer 30 in an emission reverse direction Da2 is 0.96 as in the first embodiment. Therefore, net coupling efficiency of the spot size converter 1 is 0.82 as shown in FIG. 20. Therefore, the spot size converter 1 according to the present embodiment can improve the coupling efficiency of the spot size converter 1 as compared with a comparative converter 100 formed by stacking a lower core layer 110 and an upper core layer 120 in the second direction Db.

As described above, in the spot size converter 1 in which the first core surface 25 and the second core surface 31 overlap in the second direction Db, when the first core layer 20 and the second core layer 30 are provided, the first core layer 20 and the second core layer 30 can be provided on the same first cladding layer 11.

Regarding this, when the first core surface 25 and the second core surface 31 do not overlap in the second direction Db as in the first embodiment, it is necessary to form the second core layer 30 on the first cladding layer 11 and then form the first core layer 20 on the second cladding layer 12 different from the first cladding layer 11. In this case, a manufacturing process of forming a cladding layer for each of the first core layer 20 and the second core layer 30 is required, and a manufacturing process of removing the second cladding layer 12 provided on the second core layer 30 is required.

However, according to the present embodiment, compared to the case where the first core surface 25 and the second core surface 31 do not overlap in the second direction Db, the third cladding layer 13 can be made unnecessary, and the manufacturing process of removing the second cladding layer 12 can be reduced.

Accordingly, a manufacturing process of manufacturing the spot size converter 1 can be simplified.

### Third Embodiment

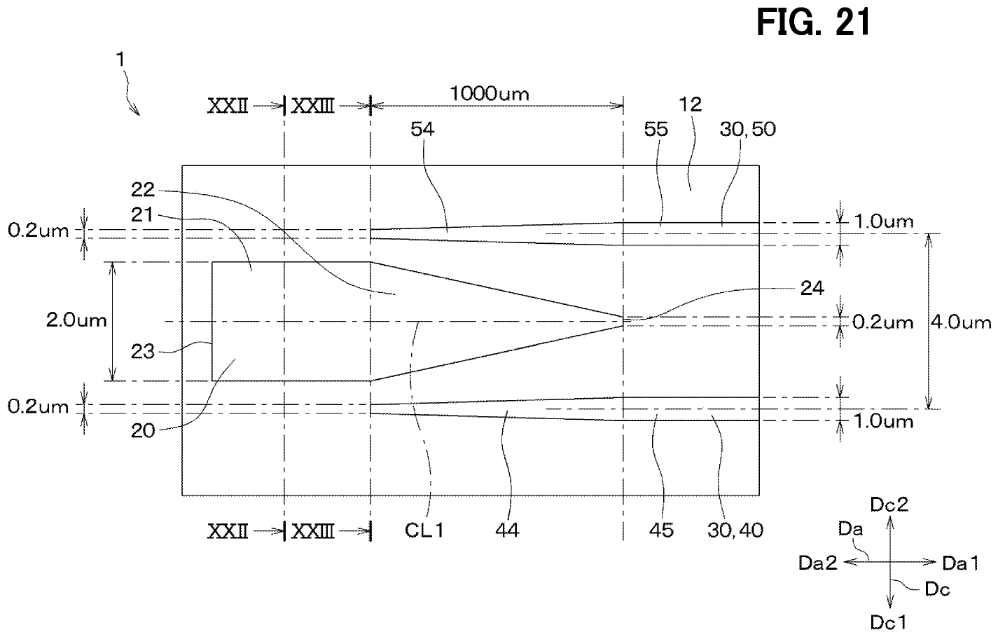

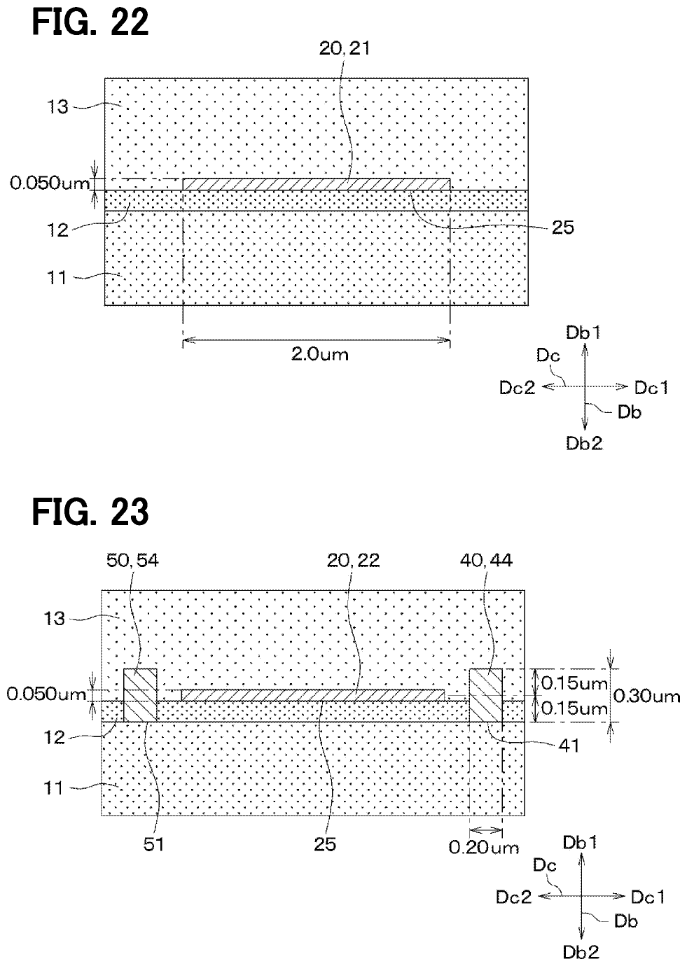

Next, a third embodiment will be described with reference to FIGS. 21 to 26. The present embodiment is different from the first embodiment in that a second core layer 30 is provided on a first core layer 20 in each of a one-side third direction Dc1 and the other-side third direction Dc2. The other configuration is the same as that of the first embodiment. Therefore, in the present embodiment, portions different from the first embodiment will be mainly described, and description of portions similar to the first embodiment may be omitted.

In a spot size converter 1 according to the present embodiment, as shown in FIGS. 21 to 23, another second core layer 30 is provided on the first core layer 20 in the other-side third direction Dc2 as compared with the first embodiment. That is, in the spot size converter 1 according to the present embodiment, the second core layers 30 are provided one on each of the one side and the other side of the first core layer 20 in a third direction Dc. Hereinafter, among the two second core layers 30, a core layer provided on the first core layer 20 in the one-side third direction Dc1 is referred to as a one-side second core layer 40, and a core layer provided on the first core layer 20 in the other-side third direction Dc2 is referred to as the other-side second core layer 50. The one-side second core layer 40 corresponds to the second core layer 30 described in the first embodiment.

The other-side second core layer 50 is disposed at a position symmetrical to the one-side second core layer 40 with respect to a first virtual line CL1 extending along a first direction Da and passing through a center of the first core layer 20 in the third direction Dc. The other-side second core layer 50 has a shape that is line-symmetrical to the one-side second core layer 40 with respect to the first virtual line CL1. That is, the one-side second core layer 40 and the other-side second core layer 50 are provided to have symmetrical arrangements and symmetrical shapes in the third direction Dc with the first virtual line CL1 interposed therebetween.

The one-side second core layer 40 and the other-side second core layer 50 are provided such that a center-to-center distance thereof in the third direction Dc is 4.0 μm. In other words, the one-side second core layer 40 is spaced apart from the first core layer 20 in the one-side third direction Dc1 such that an interval between a center of the one-side second core layer 40 in the third direction Dc and the center of the first core layer 20 in the third direction Dc is 2.0 μ. The other-side second core layer 50 is spaced apart from the first core layer 20 in the other-side third direction Dc2 such that an interval between a center of the other-side second core layer 50 in the third direction Dc and the center of the first core layer 20 in the third direction Dc is 2.0 μm.

That is, the one-side second core layer 40 and the other-side second core layer 50 are provided such that the interval between the center of the one-side second core layer 40 in the third direction Dc and the center of the first core layer 20 in the third direction Dc is equal to the interval between the center of the other-side second core layer 50 in the third direction Dc and the center of the first core layer 20 in the third direction Dc.

The one-side second core layer 40 and the other-side second core layer 50 are made of silicon nitride which is the same material as that of the first core layer 20.

As shown in FIG. 23, the one-side second core layer 40 has a one-side second core surface 41 that is a surface on a first cladding layer 11 side in a second direction Db. The one-side second core surface 41 is a surface in contact with the first cladding layer 11 on which the one-side second core layer 40 is provided. As shown in FIG. 21, the one-side second core layer 40 includes a one-side second tapered portion 44 and a one-side second propagation portion 45. The one-side second tapered portion 44 and the one-side second propagation portion 45 are provided in this order along an emission direction Da1.

The other-side second core layer 50 has the other-side second core surface 51 that is a surface on the first cladding layer 11 side in the second direction Db. The other-side second core surface 51 is a surface in contact with the first cladding layer 11 on which the other-side second core layer 50 is provided. The other-side second core layer 50 includes the other-side second tapered portion 54 and the other-side second propagation portion 55. The other-side second tapered portion 54 and the other-side second propagation portion 55 are provided in this order along the emission direction Da1.

The one-side second tapered portion 44 of the one-side second core layer 40 has the same shape as a second tapered portion 34 of the second core layer 30 described in the first embodiment. The one-side second propagation portion 45 of the one-side second core layer 40 has the same shape as a second propagation portion 35 of the second core layer 30 described in the first embodiment. Therefore, detailed description of the one-side second tapered portion 44 and the one-side second propagation portion 45 is omitted. Since the other-side second core layer 50 has the same shape as the one-side second core layer 40, detailed description thereof is omitted.

The one-side second core surface 41 and the other-side second core surface 51 do not overlap a first core surface 25 in the second direction Db, and is positioned on a stacking reverse direction Db2 side with respect to the first core surface 25.

In manufacturing of the spot size converter 1 according to the present embodiment, first, the first cladding layer 11 is formed on a substrate (not shown). Then, the one-side second core layer 40 and the other-side second core layer 50 are formed on the first cladding layer 11 by patterning. Thereafter, a second cladding layer 12 is formed on the one-side second core layer 40, on the other-side second core layer 50, and on portions of the first cladding layer 11 on which the one-side second core layer 40 and the other-side second core layer 50 are not formed. The second cladding layer 12 formed on the one-side second core layer 40 and the other-side second core layer 50 is removed by, for example, CMP.

Thereafter, the first core layer 20 is formed on the second cladding layer 12 by patterning. A third cladding layer 13 is formed on the first core layer 20, on the one-side second core layer 40, on the other-side second core layer 50, and on portions of the second cladding layer 12 on which the first core layer 20, the one-side second core layer 40, and the other-side second core layer 50 are not formed. Accordingly, the first core layer 20, the one-side second core layer 40, and the other-side second core layer 50 are covered with the third cladding layer 13.

Thereafter, unnecessary portions of the third cladding layer 13 formed on the first core layer 20, the one-side second core layer 40, and the other-side second core layer 50 are removed by, for example, CMP. Accordingly, the spot size converter 1 in which the first cladding layer 11 to the third cladding layer 13, the first core layer 20, the one-side second core layer 40, and the other-side second core layer 50 are provided on the substrate (not shown) is manufactured.

Next, an operation of the spot size converter 1 according to the present embodiment will be described. In the spot size converter 1 according to the present embodiment, when a laser light is propagated from the optical fiber waveguide path FW to the first propagation portion 21 of the first core layer 20, the laser light is propagated through the first propagation portion 21 along the emission direction Da1, and is propagated from the first propagation portion 21 to the first tapered portion 22. The laser light propagated to the first tapered portion 22 is propagated through the first tapered portion 22 along the emission direction Da1.

The laser light propagated through the first tapered portion 22 gradually transitions to the one-side second tapered portion 44 and the other-side second tapered portion 54.

The one-side second core layer 40 and the other-side second core layer 50 are provided such that the interval between the center of the one-side second core layer 40 in the third direction Dc and the center of the first core layer 20 in the third direction Dc is equal to the interval between the center of the other-side second core layer 50 in the third direction Dc and the center of the first core layer 20 in the third direction Dc. Therefore, the laser light that transitions from the first tapered portion 22 to the one-side second tapered portion 44 and the other-side second tapered portion 54 transitions in a state where phases thereof are substantially aligned.

The laser lights that have transitioned to the one-side second tapered portion 44 and the other-side second tapered portion 54 are propagated through the one-side second tapered portion 44 and the other-side second tapered portion 54 along the emission direction Da1. The laser light propagated through the one-side second tapered portion 44 is propagated from the one-side second tapered portion 44 to the one-side second propagation portion 45. The laser light propagated through the other-side second tapered portion 54 is propagated from the other-side second tapered portion 54 to the other-side second propagation portion 55. The laser lights propagated to the one-side second propagation portion 45 and the other-side second propagation portion 55 are propagated to a circuit waveguide path CW.

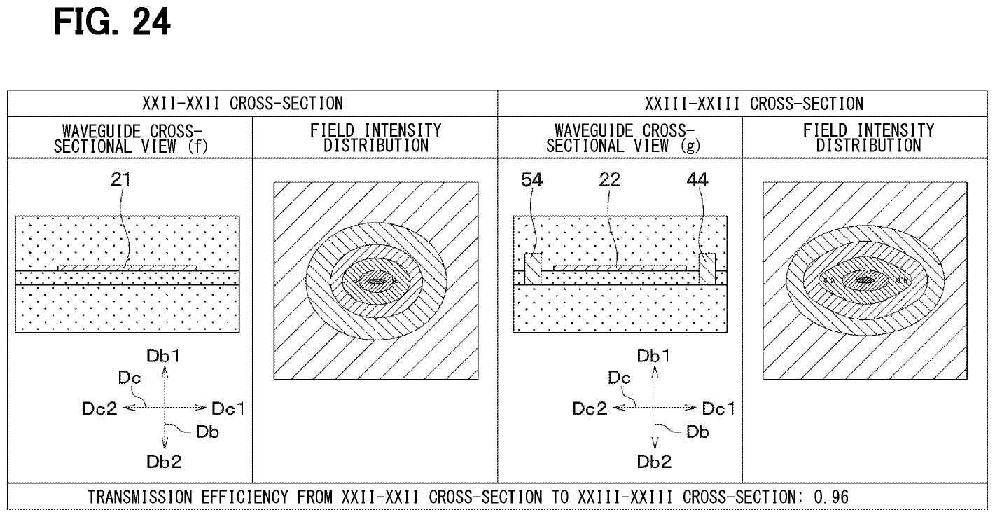

A waveguide path of the spot size converter 1 according to the present embodiment includes the first core layer 20, the one-side second core layer 40, and the other-side second core layer 50. As shown in FIG. 24, a cross-sectional shape of the waveguide path orthogonal to the emission direction Da1 immediately before the laser light passes through end portions of the one-side second core layer 40 and the other-side second core layer 50 in an emission reverse direction Da2 is a shape of the first core layer 20.

Regarding this, a cross-sectional shape of the waveguide path orthogonal to the emission direction Da1 immediately after the laser light passes through the end portions of the one-side second core layer 40 and the other-side second core layer 50 in the emission reverse direction Da2 is a cross-sectional shape in which the first core layer 20, the one-side second core layer 40, and the other-side second core layer 50 are disposed. Specifically, the cross-sectional shape is a cross-sectional shape in which the one-side second core layer 40 and the other-side second core layer 50 are spaced apart from the first core layer 20 and are disposed on the one side and the other side of the first core layer 20 in the third direction Dc.

Among cross-sectional views of the waveguide path shown in FIG. 24, a waveguide path cross-sectional view f is a cross-sectional view taken along a line XXII-XXII of the first propagation portion 21 of the first core layer 20 shown in FIG. 21. A waveguide path cross-sectional view g is a cross-sectional view taken along a line XXIII-XXIII of the end portions of the one-side second core layer 40 and the other-side second core layer 50 in the emission reverse direction Da2.

In the spot size converter 1 configured as described above, the first core layer 20 can confine expansion of the laser light in the third direction Dc. Therefore, immediately after the laser light passes through the end portions of the one-side second core layer 40 and the other-side second core layer 50 in the emission reverse direction Da2, a change in optical confinement in the third direction Dc can be limited. That is, immediately after the laser light passes through the end portions of the one-side second core layer 40 and the other-side second core layer 50 in the emission reverse direction Da2, a rapid change in an optical confinement coefficient in the third direction Dc can be limited.

Therefore, as shown in FIG. 24, the spot size converter 1 can reduce a change in an electric field intensity distribution of the laser light when the laser light passes through the end portions of the one-side second core layer 40 and the other-side second core layer 50 in the emission reverse direction Da2 as compared with a comparative converter 100.

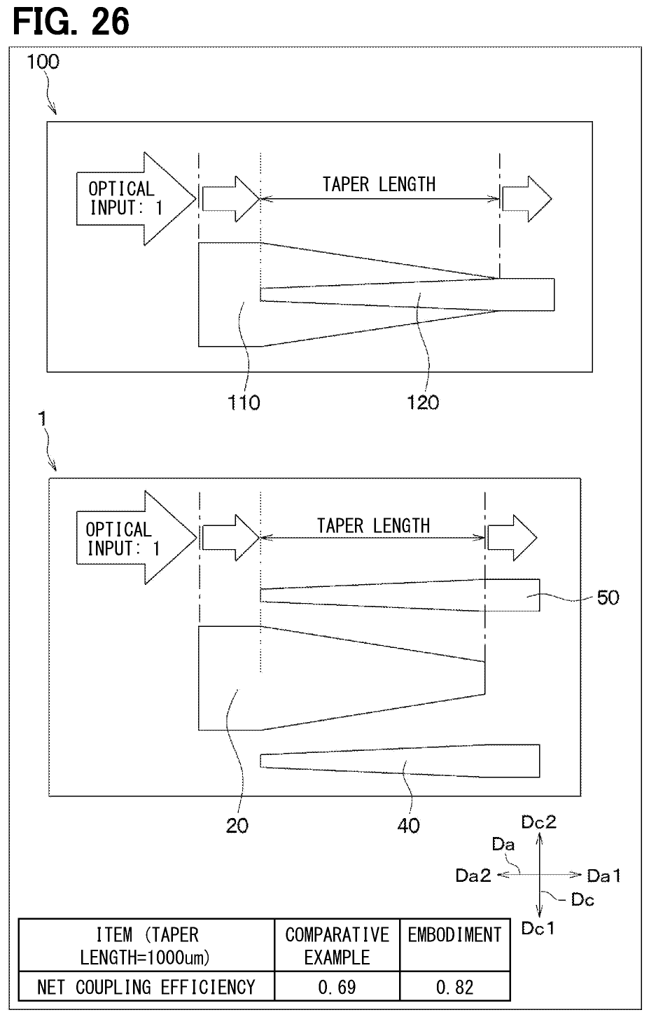

In the spot size converter 1 configured as described above, a light transmittance when a light is propagated from the first core layer 20 to an end portion of the second core layer 30 in an emission reverse direction Da2 is 0.96 as in the first embodiment. Therefore, net coupling efficiency of the spot size converter 1 is 0.82 as shown in FIG. 26. Therefore, the spot size converter 1 according to the present embodiment can improve the coupling efficiency of the spot size converter 1 as compared with a comparative converter 100 formed by stacking a lower core layer 110 and an upper core layer 120 in the second direction Db.

In the spot size converter 1, the coupling efficiency from the end portions of the one-side second core layer 40 and the other-side second core layer 50 in the emission reverse direction Da2 to the end portions in the emission direction Da1 can be increased as a taper length is increased.

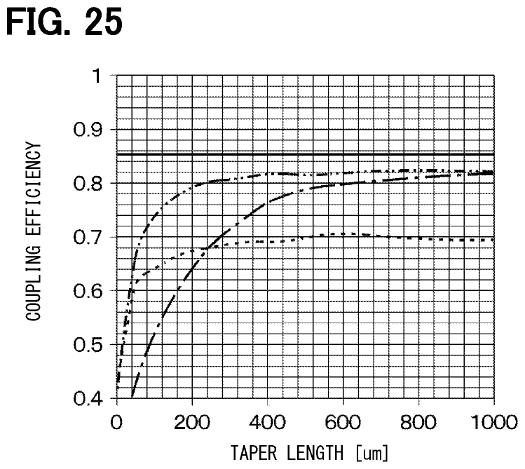

The spot size converter 1 according to the present embodiment includes the other-side second core layer 50 in addition to the one-side second core layer 40. Therefore, compared to a configuration in which the second core layer 30 is provided only on the one side or the other side of the first core layer 20 in the third direction Dc, the transition of the laser light from the first core layer 20 is easily performed. Accordingly, as shown in FIG. 25, an increment of the coupling efficiency with respect to an increment of the taper length can be made larger than that of the spot size converter 1 according to the first embodiment. That is, in a correlation between the taper length and the coupling efficiency, the coupling efficiency with respect to the taper length can be easily increased.

For example, in the first embodiment, when the taper length is set to 1000 μm, the net coupling efficiency between the first core layer 20 and the second core layer 30 can be increased to 0.82. Regarding this, in the spot size converter 1 according to the present embodiment, even when the taper length is set to about 400 μm which is smaller than that of the first embodiment, the net coupling efficiency can be increased to 0.82 which is the same net coupling efficiency as that of the first embodiment.

A solid line shown in FIG. 25 indicates coupling efficiency at a position of an end portion of a lower tapered portion 111 in the emission reverse direction Da2. A dashed line indicates coupling efficiency at a position of an end portion of the lower tapered portion 111 in the emission direction Da1 in the comparative converter 100. A one-dot chain line indicates the coupling efficiency at the position of the end portion of the lower tapered portion 111 in the emission direction Da1 according to the first embodiment. A two-dot chain line indicates the coupling efficiency at the position of the end portion of the lower tapered portion 111 in the emission direction Da1 according to the present embodiment.

As described above, the spot size converter 1 according to the present embodiment can improve the coupling efficiency of the spot size converter 1 as compared with the comparative converter 100 formed by stacking the lower core layer 110 and the upper core layer 120 in the second direction Db.

The spot size converter 1 according to the present embodiment includes the one-side second core layer 40 provided on the first core layer 20 in the one-side third direction Dc1, and the other-side second core layer 50 provided on the first core layer 20 in the other-side third direction Dc2.

Accordingly, compared to a case where the second core layer 30 is provided only on the one side or the other side of the first core layer 20 in the third direction Dc, the transition of the laser light from the first tapered portion 22 can be easily performed.

Therefore, compared to a case where the configuration is not formed as described above, even when sizes of the one-side second core layer 40 and the other-side second tapered portion 54 in the first direction Da are reduced, the transition of the laser light from the first tapered portion 22 can be sufficiently performed. Therefore, a size of the spot size converter 1 in the first direction Da can be reduced, and a size of a housing of the spot size converter 1 can be reduced.

### Fourth Embodiment

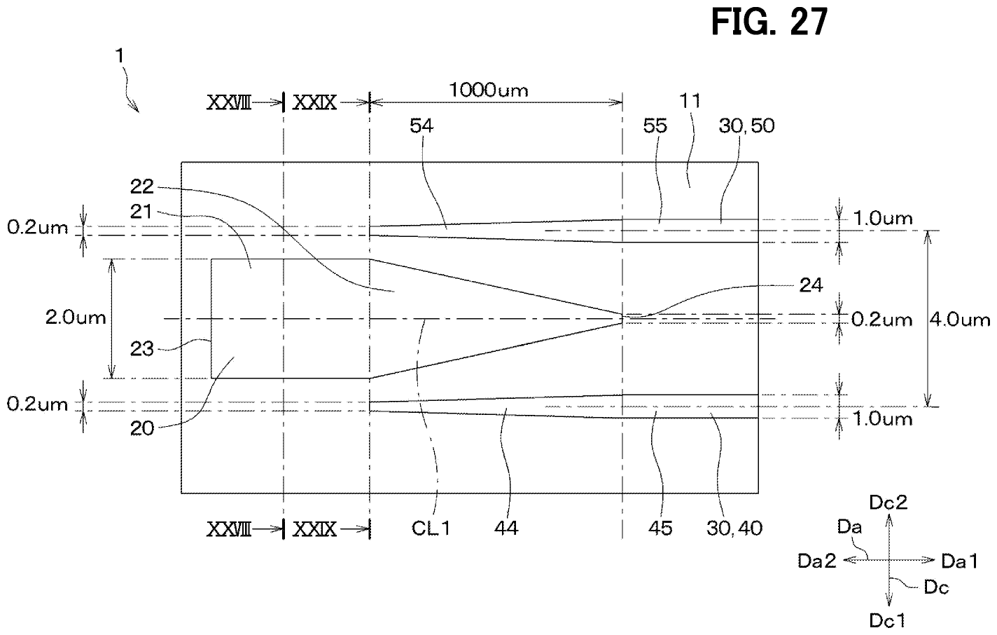

Next, a fourth embodiment will be described with reference to FIGS. 27 to 30. The present embodiment is different from the third embodiment in a positional relationship in a second direction Db between a first core layer 20 and a one-side second core layer 40 and between the first core layer 20 and the other-side second core layer 50. The other configuration is the same as that of the third embodiment. Therefore, in the present embodiment, portions different from the third embodiment will be mainly described, and description of portions similar to the third embodiment may be omitted.

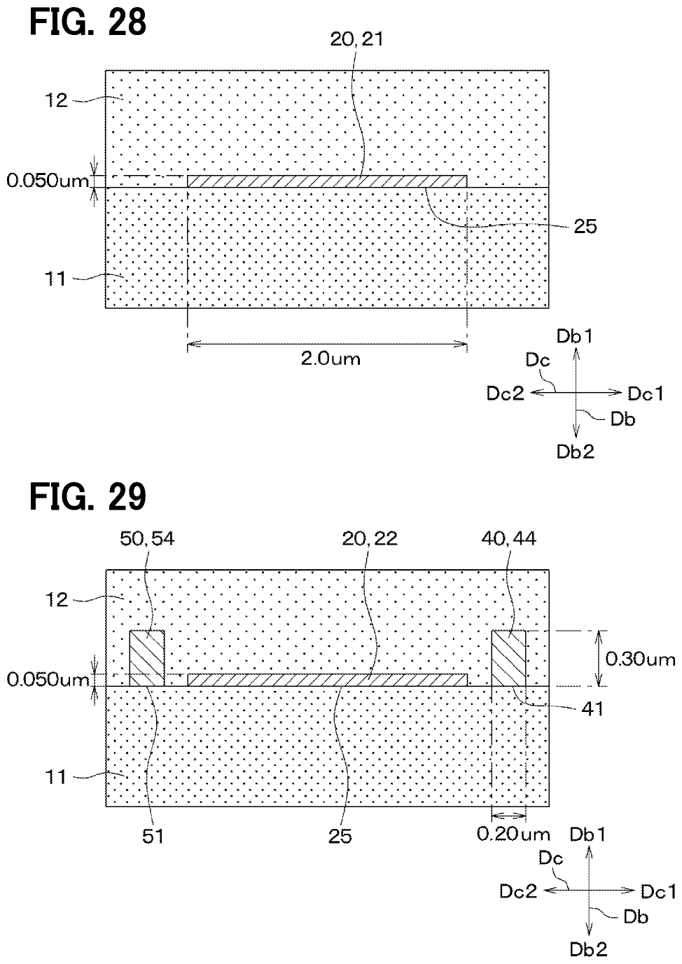

In a spot size converter 1 according to the present embodiment, as shown in FIGS. 27 to 29, a third cladding layer 13 is not provided as compared with the third embodiment. As shown in FIGS. 28 and 29, the spot size converter 1 according to the present embodiment is different from the third embodiment in that the first core layer 20 is provided on a first cladding layer 11. The first core layer 20 is provided on the first cladding layer 11 on which the one-side second core layer 40 and the other-side second core layer 50 are provided. In other words, the first cladding layer 11 on which the first core layer 20 is provided is the same cladding layer as the first cladding layer 11 on which the one-side second core layer 40 and the other-side second core layer 50 are provided. Therefore, a one-side second core surface 41 and the other-side second core surface 51 according to the present embodiment overlap a first core surface 25 in the second direction Db.

In manufacturing of the spot size converter 1 according to the present embodiment, first, the first cladding layer 11 is formed on a substrate (not shown). Then, the first core layer 20, the one-side second core layer 40, and the other-side second core layer 50 are formed on the first cladding layer 11 by patterning. Thereafter, a second cladding layer 12 is formed on the first core layer 20, on the one-side second core layer 40, on the other-side second core layer 50, and on portions of the first cladding layer 11 on which the first core layer 20, the one-side second core layer 40, and the other-side second core layer 50 are not formed. Accordingly, the first core layer 20, the one-side second core layer 40, and the other-side second core layer 50 are covered with the second cladding layer 12.

Then, unnecessary portions of the second cladding layer 12 formed on the first core layer 20, the one-side second core layer 40, and the other-side second core layer 50 are removed by, for example, CMP. Accordingly, the spot size converter 1 in which the first cladding layer 11, the second cladding layer 12, the first core layer 20, the one-side second core layer 40, and the other-side second core layer 50 are provided on the substrate (not shown) is manufactured.

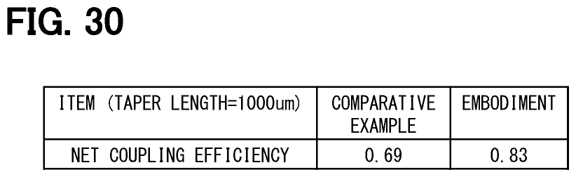

Net coupling efficiency of the spot size converter 1 thus configured is 0.83 as shown in FIG. 30. Therefore, the spot size converter 1 according to the present embodiment can improve the coupling efficiency of the spot size converter 1 as compared with a comparative converter 100 formed by stacking a lower core layer 110 and an upper core layer 120 in the second direction Db.

The one-side second core layer 40 according to the present embodiment is stacked on the first cladding layer 11, and has the one-side second core surface 41 that is a surface on the first cladding layer 11 side in the second direction Db. The other-side second core layer 50 is stacked on the first cladding layer 11, and has the other-side second core surface 51 that is a surface on the first cladding layer 11 side in the second direction Db. The one-side second core surface 41 and the other-side second core surface 51 overlap in the second direction Db.

As described above, in the spot size converter 1 in which the first core surface 25, the one-side second core surface 41, and the other-side second core surface 51 overlap in the second direction Db, the first core layer 20, the one-side second core layer 40, and the other-side second core layer 50 can be provided on the same first cladding layer 11.

Regarding this, when the first core surface 25, the one-side second core surface 41, and the other-side second core surface 51 do not overlap in the second direction Db as in the third embodiment, the one-side second core layer 40 and the other-side second core layer 50 are provided on the first cladding layer 11. Thereafter, it is necessary to provide the first core layer 20 on the second cladding layer 12 different from the first cladding layer 11. In this case, in addition to a manufacturing process of forming the first cladding layer 11 for forming the one-side second core layer 40 and the other-side second core layer 50, a manufacturing process of forming the second cladding layer 12 for forming the first core layer 20 is required. Before forming the first core layer 20, a manufacturing process of removing the second cladding layer 12 provided on the one-side second core layer 40 and the other-side second core layer 50 is required.

However, according to the present embodiment, the third cladding layer 13 can be made unnecessary as compared with a case where the first core surface 25, the one-side second core surface 41, and the other-side second core surface 51 do not overlap in the second direction Db. Further, the manufacturing process of removing the second cladding layer 12 can be reduced. Accordingly, a manufacturing process of manufacturing the spot size converter 1 can be simplified.

### Fifth Embodiment

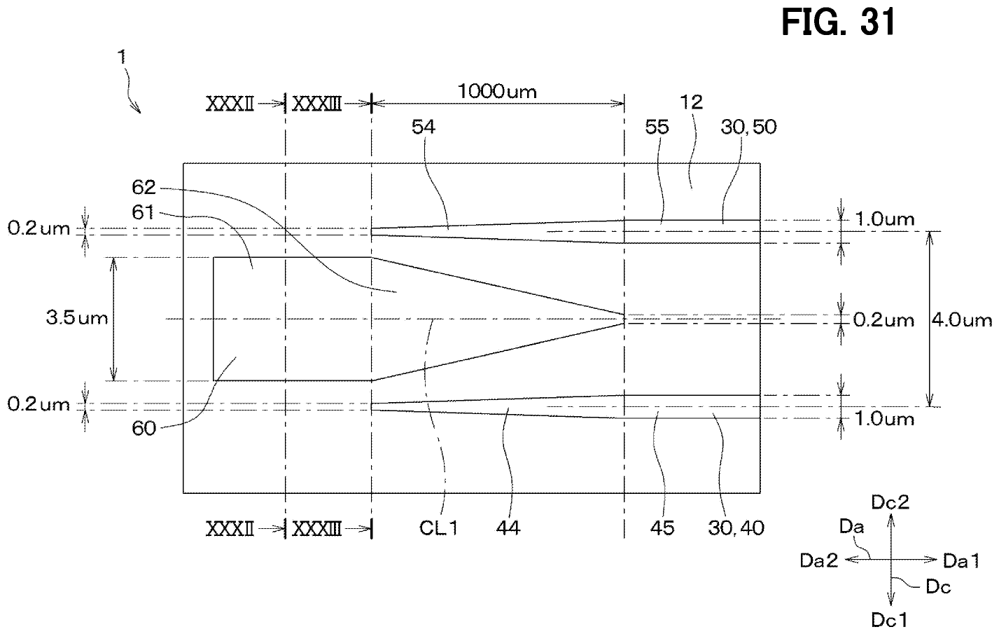

Next, a fifth embodiment will be described with reference to FIGS. 31 to 34. The present embodiment is different from the third embodiment in that two first core layers 60 and 70 are provided. The other configuration is the same as that of the third embodiment. Therefore, in the present embodiment, portions different from the third embodiment will be mainly described, and description of portions similar to the third embodiment may be omitted.

As shown in FIGS. 31 to 33, a spot size converter 1 according to the present embodiment includes a fourth cladding layer 14 in addition to a first cladding layer 11 to a third cladding layer 13, and also includes the two first core layers 60 and 70. One of the two first core layers 60 and 70 is provided on a stacking forward direction Db1 side in a second direction Db with respect to the one-side second core layer 40 and the other-side second core layer 50. Regarding this, the other of two first core layers 20 is provided on a stacking reverse direction Db2 side in the second direction Db with respect to the one-side second core layer 40 and the other-side second core layer 50. In FIG. 31, the third cladding layer 13 and the fourth cladding layer 14 are omitted.

Hereinafter, among the two first core layers 20, a core layer provided on the stacking reverse direction Db2 side with respect to the one-side second core layer 40 and the other-side second core layer 50 is also referred to as a lower first core layer 60. Among the two first core layers 20, a core layer provided on the stacking forward direction Db1 side with respect to the one-side second core layer 40 and the other-side second core layer 50 is also referred to as an upper first core layer 70.

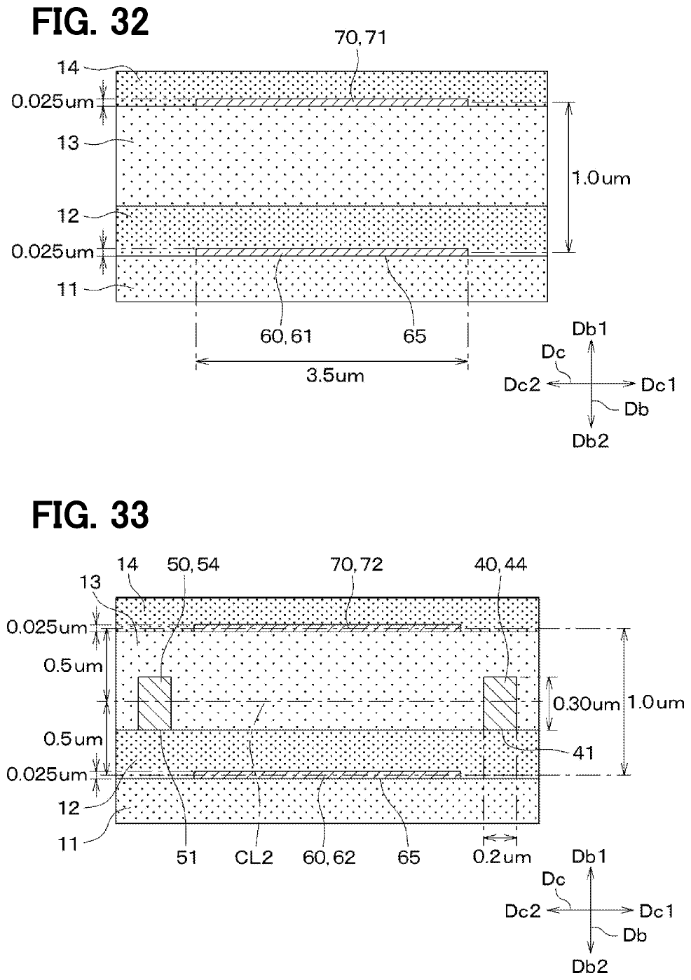

As shown in FIGS. 32 and 33, the first cladding layer 11, the second cladding layer 12, the third cladding layer 13, and the fourth cladding layer 14 are stacked along the second direction Db. Specifically, the first cladding layer 11, the second cladding layer 12, the third cladding layer 13, and the fourth cladding layer 14 are stacked in this order along the stacking forward direction Db1.

The lower first core layer 60 and the second cladding layer 12 are provided on the first cladding layer 11. The one-side second core layer 40, the other-side second core layer 50, and the third cladding layer 13 are provided on the second cladding layer 12. The upper first core layer 70 and the fourth cladding layer 14 are provided on the third cladding layer 13.

The first cladding layer 11, the second cladding layer 12, the third cladding layer 13, and the fourth cladding layer 14 are made of, for example, silicon dioxide (that is, SiO₂) as an insulator.

The lower first core layer 60 is provided on the stacking reverse direction Db2 side with respect to the one-side second core layer 40 and the other-side second core layer 50, and is provided on the first cladding layer 11 different from the second cladding layer 12 on which the one-side second core layer 40 and the other-side second core layer 50 are provided. The upper first core layer 70 is provided on the stacking forward direction Db1 side with respect to the one-side second core layer 40 and the other-side second core layer 50, and is provided on the third cladding layer 13 different from the second cladding layer 12 on which the one-side second core layer 40 and the other-side second core layer 50 are provided.

The lower first core layer 60 is disposed at a position symmetrical to the upper first core layer 70 with respect to a second virtual line CL2 extending along a third direction Dc and passing through centers of the one-side second core layer 40 and the other-side second core layer 50 in the second direction Db. The lower first core layer 60 has a shape that is line-symmetrical to the upper first core layer 70 with respect to the second virtual line CL2. That is, the lower first core layer 60 and the upper first core layer 70 are provided to have symmetrical arrangements and symmetrical shapes in the second direction Db with the second virtual line CL2 interposed therebetween.

The lower first core layer 60 and the upper first core layer 70 are provided such that a center-to-center distance thereof in the second direction Db is 1.0 μm. In other words, the lower first core layer 60 is provided such that an interval between a center of the lower first core layer 60 in the second direction Db and the centers of the one-side second core layer 40 and the other-side second core layer 50 in the second direction Db is 0.5 μm. The upper first core layer 70 is provided such that an interval between a center of the upper first core layer 70 in the second direction Db and the centers of the one-side second core layer 40 and the other-side second core layer 50 in the second direction Db is 0.5 μm.

That is, the lower first core layer 60 and the upper first core layer 70 are provided such that the interval between the center of the lower first core layer 60 in the second direction Db and the centers of the one-side second core layer 40 and the other-side second core layer 50 in the second direction Db is equal to the interval between the center of the upper first core layer 70 in the second direction Db and the centers of the one-side second core layer 40 and the other-side second core layer 50 in the second direction Db.

The lower first core layer 60 includes a lower first propagation portion 61 and a lower first tapered portion 62. The lower first propagation portion 61 and the lower first tapered portion 62 are provided in this order along an emission direction Da1. The upper first core layer 70 includes an upper first propagation portion 71 and an upper first tapered portion 72. The upper first propagation portion 71 and the upper first tapered portion 72 are provided in this order along the emission direction Da1.

The lower first core layer 60 and the upper first core layer 70 according to the present embodiment have the same shape. Therefore, in the following description, only a shape of the lower first core layer 60 will be described in detail, and detailed description of a shape of the upper first core layer 70 will be omitted.

As shown in FIGS. 31 and 32, the lower first core layer 60 extends along a first direction Da at a substantially center on the first cladding layer 11 in the third direction Dc. The lower first core layer 60 is formed in a thin flat shape in which a size of the lower first core layer 60 in the second direction Db is smaller than a size thereof in the third direction Dc. The lower first core layer 60 is made of silicon nitride. The first core layer 20 is spaced apart from an end portion of the spot size converter 1 in the emission reverse direction Da2.

The lower first core layer 60 has a lower first core surface 65 that is a surface on the first cladding layer 11 side in the second direction Db. The lower first core surface 65 is a surface in contact with the first cladding layer 11 on which the lower first core layer 60 is provided.

A size of the lower first propagation portion 61 in the second direction Db and a size of the lower first propagation portion 61 in the third direction Dc from an end portion on the emission reverse direction Da2 side in the first direction Da to an end portion on the emission direction Da1 side are constant. The size of the lower first propagation portion 61 in the second direction Db is smaller than a size of a first propagation portion 21 of the first core layer 20 according to the third embodiment, and the size of the lower first propagation portion 61 in the third direction Dc is larger than a size of the first propagation portion 21. Specifically, the size of the lower first propagation portion 61 in the second direction Db is 0.025 μm and the size of the lower first propagation portion 61 in the third direction Dc is 3.5 μm. The lower first propagation portion 61 is provided on the emission reverse direction Da2 side with respect to the one-side second core layer 40 and the other-side second core layer 50. That is, the lower first propagation portion 61 is provided at a position not overlapping the one-side second core layer 40 and the other-side second core layer 50 in the third direction Dc. The lower first propagation portion 61 is connected to the lower first tapered portion 62 on the emission direction Da1 side. The lower first tapered portion 62 is disposed on an end portion of the lower first core layer 60 on the emission direction Da1 side in the first direction Da.

A size of the lower first tapered portion 62 in the second direction Db from an end portion on the emission reverse direction Da2 side in the first direction Da to an end portion on the emission direction Da1 side is constant. In contrast, a size of the lower first tapered portion 62 in the third direction Dc from the end portion on the emission reverse direction Da2 side in the first direction Da to the end portion on the emission direction Da1 side gradually decreases along the emission direction Da1. The size of the lower first tapered portion 62 in the second direction Db is smaller than a size of a first tapered portion 22 according to the third embodiment, and the size of the lower first tapered portion 62 in the first direction Da is larger than a size of the first tapered portion 22.

Specifically, for the size of the lower first tapered portion 62 in the third direction Dc, the size of the end portion on the emission reverse direction Da2 side is 3.5 μm, and the size of the end portion on the emission direction Da1 side is 0.2 μm. The size of the lower first tapered portion 62 in the third direction Dc from the end portion on the emission reverse direction Da2 side in the first direction Da to the end portion on the emission direction Da1 side continuously decreases. The size of the lower first tapered portion 62 in the first direction Da is 1000 μm.

For the lower first tapered portion 62, the size of the end portion, which is on the emission direction Da1 side, in the third direction Dc is the smallest size that can be minimized in a manufacturing process to be used. The lower first tapered portion 62 is provided at a position where the entire lower first tapered portion 62 overlaps the one-side second core layer 40 and the other-side second core layer 50 in the third direction Dc.

Diameters of end portions of a one-side second tapered portion 44 and the other-side second tapered portion 54 on the emission reverse direction Da2 side according to the present embodiment are 0.2 μm. For the one-side second tapered portion 44 and the other-side second tapered portion 54, sizes of the end portions, which are on the emission reverse direction Da2 side, in the third direction Dc are the smallest size that can be minimized in the manufacturing process to be used.

The one-side second tapered portion 44 and the other-side second tapered portion 54 are all provided at positions respectively overlapping the lower first tapered portion 62 and the upper first tapered portion 72 in the third direction Dc.

Therefore, the positions of the end portions of the lower first tapered portion 62 and the upper first tapered portion 72, which are on the emission reverse direction Da2 side, in the first direction Da match the positions of the end portions of the one-side second tapered portion 44 and the other-side second tapered portion 54, which are on the emission reverse direction Da2 side, in the first direction Da. The positions of the end portions of the lower first tapered portion 62 and the upper first tapered portion 72, which are on the emission direction Da1 side, in the first direction Da match the positions of the end portions of the one-side second tapered portion 44 and the other-side second tapered portion 54, which are on the emission direction Da1 side, in the first direction Da.

In manufacturing of the spot size converter 1 according to the present embodiment, first, the first cladding layer 11 is formed on a substrate (not shown). Then, the lower first core layer 60 is formed on the first cladding layer 11 by patterning, and thereafter, the second cladding layer 12 is formed on the lower first core layer 60 and a portion of the first cladding layer 11 on which the lower first core layer 60 is not formed. Accordingly, the lower first core layer 60 is covered with the second cladding layer 12. Then, unnecessary portions of the second cladding layer 12 formed on the lower first core layer 60 are removed by, for example, CMP.

The one-side second core layer 40 and the other-side second core layer 50 are formed on the second cladding layer 12 by patterning. Thereafter, the third cladding layer 13 is formed on the one-side second core layer 40, on the other-side second core layer 50, and on portions of the second cladding layer 12 on which the one-side second core layer 40 and the other-side second core layer 50 are not formed. Accordingly, the one-side second core layer 40 and the other-side second core layer 50 are covered with the third cladding layer 13. Then, unnecessary portions of the third cladding layer 13 formed on the one-side second core layer 40 and the other-side second core layer 50 are removed by, for example, CMP.

The upper first core layer 70 is formed on the third cladding layer 13 by patterning, and then the fourth cladding layer 14 is formed on the upper first core layer 70 and a portion of the third cladding layer 13 on which the upper first core layer 70 is not formed. Accordingly, the upper first core layer 70 is covered with the fourth cladding layer 14. Then, unnecessary portions of the fourth cladding layer 14 formed on the upper first core layer 70 are removed by, for example, CMP.

Accordingly, the spot size converter 1 in which the first cladding layer 11 to the fourth cladding layer 14, the lower first core layer 60, the upper first core layer 70, the one-side second core layer 40, and the other-side second core layer 50 are provided on the substrate (not shown) is manufactured. The lower first core layer 60 and the upper first core layer 70 configured as described above are provided side by side in the second direction Db with the second cladding layer 12 and the third cladding layer 13 interposed therebetween.

Next, an operation of the spot size converter 1 according to the present embodiment will be described. In the spot size converter 1, when a laser light is propagated from an optical fiber waveguide path FW to the lower first propagation portion 61 of the lower first core layer 60 and the upper first propagation portion 71 of the upper first core layer 70, the laser light is propagated to the lower first tapered portion 62 and the upper first tapered portion 72. The laser light propagated to the lower first tapered portion 62 and the upper first tapered portion 72 is propagated through the lower first tapered portion 62 and the upper first tapered portion 72 along the emission direction Da1.

The laser lights propagated through the lower first tapered portion 62 and the upper first tapered portion 72 gradually transition to the one-side second tapered portion 44 and the other-side second tapered portion 54.

The lower first core layer 60 and the upper first core layer 70 are provided such that the interval between the center of the lower first core layer 60 in the second direction Db and the centers of the one-side second core layer 40 and the other-side second core layer 50 in the second direction Db is equal to the interval between the center of the upper first core layer 70 in the second direction Db and the centers of the one-side second core layer 40 and the other-side second core layer 50 in the second direction Db. Further, the lower first core layer 60 and the upper first core layer 70 are provided such that an interval between a center of the lower first core layer 60 in the third direction Dc and centers of the one-side second core layer 40 and the other-side second core layer 50 in the third direction Dc is equal to an interval between a center of the upper first core layer 70 in the third direction Dc and the centers of the one-side second core layer 40 and the other-side second core layer 50 in the third direction Dc. Therefore, the laser lights that transition from the lower first tapered portion 62 and the upper first tapered portion 72 to the one-side second tapered portion 44 and the other-side second tapered portion 54 transition in a state where phases thereof are substantially aligned.

The laser lights that have transitioned to the one-side second tapered portion 44 and the other-side second tapered portion 54 are propagated through the one-side second tapered portion 44 and the other-side second tapered portion 54 along the emission direction Da1. The laser light propagated through the one-side second tapered portion 44 is propagated from the one-side second tapered portion 44 to the one-side second propagation portion 45. The laser light propagated through the other-side second tapered portion 54 is propagated from the other-side second tapered portion 54 to the other-side second propagation portion 55. The laser lights propagated to the one-side second propagation portion 45 and the other-side second propagation portion 55 are propagated to a circuit waveguide path CW.

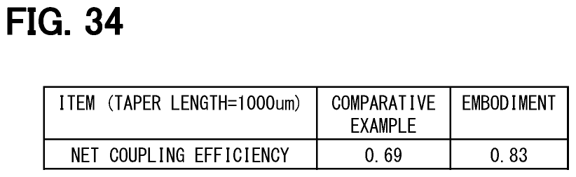

Net coupling efficiency of the spot size converter 1 thus configured is 0.83 as shown in FIG. 34. Therefore, the spot size converter 1 according to the present embodiment can improve the coupling efficiency of the spot size converter 1 as compared with a comparative converter 100 formed by stacking a lower core layer 110 and an upper core layer 120 in the second direction Db.

As described above, in the spot size converter 1 according to the present embodiment, the lower first core layer 60 and the upper first core layer 70 are provided side by side in the second direction Db with the second cladding layer 12 and the third cladding layer 13 interposed therebetween.

An optical confinement coefficient at portions on which the lower first core layer 60 and the upper first core layer 70 are provided in the spot size converter 1 can be adjusted by a distance between the lower first core layer 60 and the upper first core layer 70. Therefore, by adjusting the interval between the lower first core layer 60 and the upper first core layer 70, it is possible to adjust the optical confinement coefficient in the second direction Db at the portions on which the lower first core layer 60 and the upper first core layer 70 are provided in the spot size converter 1. Therefore, it is possible to adjust an electric field intensity distribution in the second direction Db to a desired magnitude at the portions on which the lower first core layer 60 and the upper first core layer 70 are provided in the spot size converter 1.

### Modification of Fifth Embodiment

In the fifth embodiment described above, an example in which a lower first core layer 60 and an upper first core layer 70 are provided with a second cladding layer 12 and a third cladding layer 13 interposed therebetween in a second direction Db has been described, but the present disclosure is not limited thereto. For example, a spot size converter 1 may further include one or more first core layers 20 in addition to the lower first core layer 60 and the upper first core layer 70. In this case, an optical confinement coefficient in the second direction Db in the spot size converter 1 can be adjusted by adjusting intervals of the lower first core layer 60, the upper first core layer 70, and the one or more additional first core layers 20. Accordingly, an electric field intensity distribution in the second direction Db can be adjusted.

### Sixth Embodiment

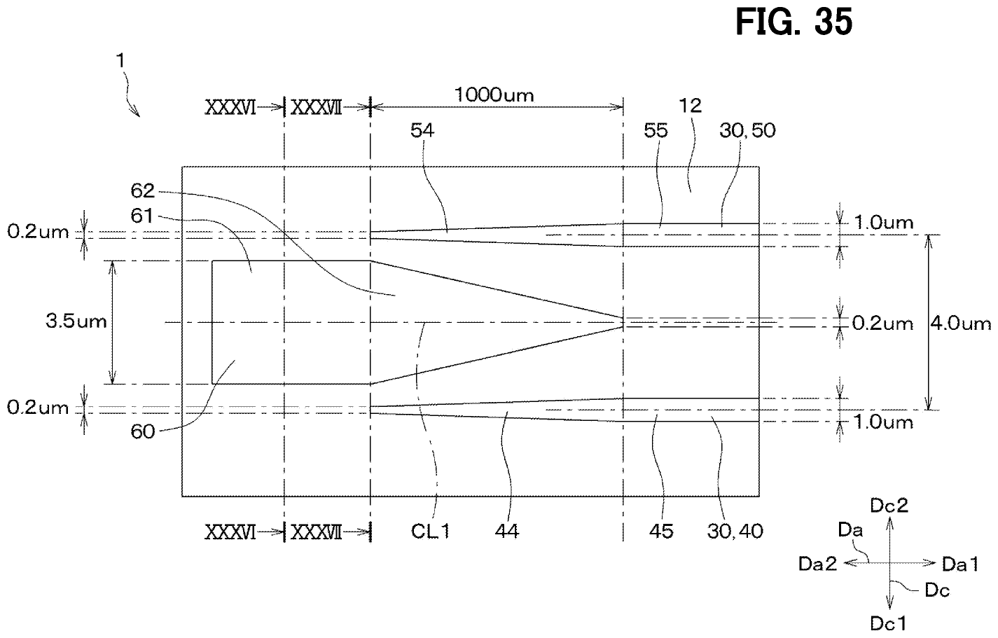

Next, a sixth embodiment will be described with reference to FIGS. 35 to 38. The present embodiment is different from the fifth embodiment in a positional relationship in a second direction Db between a lower first core layer 60 and a one-side second core layer 40 and between the lower first core layer 60 and the other-side second core layer 50. The other configuration is the same as that of the fifth embodiment. Therefore, in the present embodiment, portions different from the fifth embodiment will be mainly described, and description of portions similar to the fifth embodiment may be omitted.

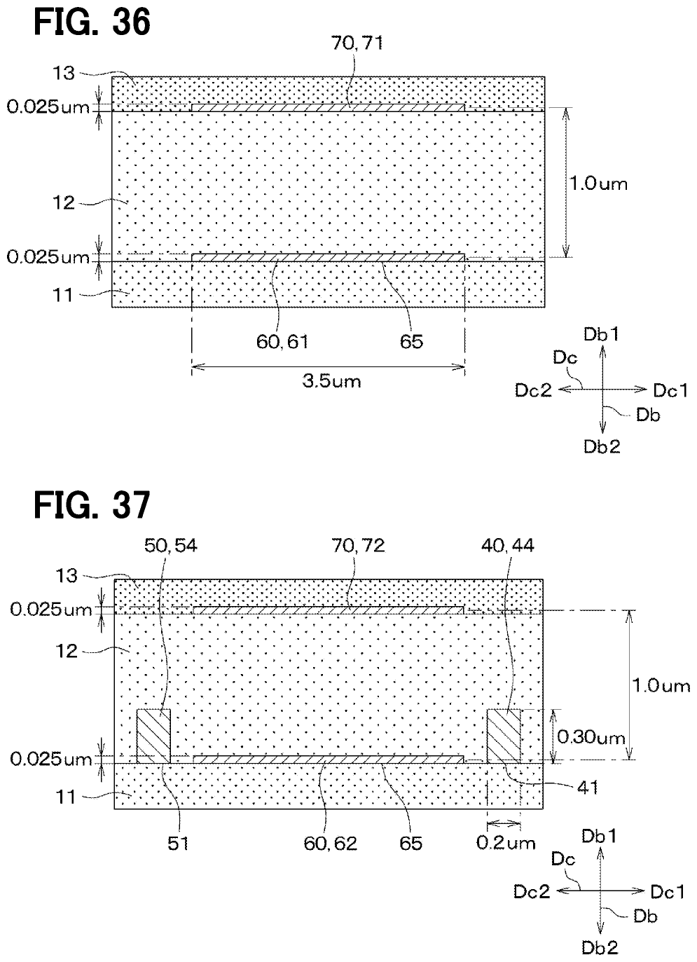

In a spot size converter 1 according to the present embodiment, as shown in FIGS. 35 to 37, a fourth cladding layer 14 is not provided as compared with the fifth embodiment. As shown in FIGS. 36 and 37, the spot size converter 1 according to the present embodiment is different from the fifth embodiment in that the one-side second core layer 40 and the other-side second core layer 50 are provided on a first cladding layer 11. Therefore, the one-side second core layer 40 and the other-side second core layer 50 are provided on the first cladding layer 11 on which the lower first core layer 60 is provided. In other words, the first cladding layer 11 on which the lower first core layer 60 is provided and the first cladding layer 11 on which the one-side second core layer 40 and the other-side second core layer 50 are provided are the same cladding layer. Therefore, a one-side second core surface 41 and the other-side second core surface 51 according to the present embodiment overlap a lower first core surface 65 in the second direction Db.

In manufacturing of the spot size converter 1 according to the present embodiment, first, the first cladding layer 11 is formed on a substrate (not shown). Then, the lower first core layer 60, the one-side second core layer 40, and the other-side second core layer 50 are formed on the first cladding layer 11 by patterning. Thereafter, a second cladding layer 12 is formed on the lower first core layer 60, on the one-side second core layer 40, on the other-side second core layer 50, and on portions of the first cladding layer 11 on which the lower first core layer 60, the one-side second core layer 40, and the other-side second core layer 50 are not formed. Accordingly, the lower first core layer 60, the one-side second core layer 40, and the other-side second core layer 50 are covered with the second cladding layer 12.

Then, unnecessary portions of the second cladding layer 12 formed on the lower first core layer 60, the one-side second core layer 40, and the other-side second core layer 50 are removed by, for example, CMP.

An upper first core layer 70 is formed on the second cladding layer 12 by patterning, and then the third cladding layer 13 is formed on the upper first core layer 70 and a portion of the second cladding layer 12 on which the upper first core layer 70 is not formed. Accordingly, the upper first core layer 70 is covered with the third cladding layer 13. Then, unnecessary portions of the third cladding layer 13 formed on the upper first core layer 70 are removed by, for example, CMP.

Accordingly, the spot size converter 1 in which the first cladding layer 11 to the third cladding layer 13, the lower first core layer 60, the upper first core layer 70, the one-side second core layer 40, and the other-side second core layer 50 are provided on the substrate (not shown) is manufactured. The lower first core layer 60 and the upper first core layer 70 configured as described above are provided side by side in the second direction Db with the second cladding layer 12 interposed therebetween.

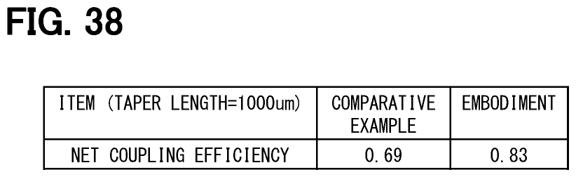

Net coupling efficiency of the spot size converter 1 thus configured is 0.83 as shown in FIG. 38. Therefore, the spot size converter 1 according to the present embodiment can improve the coupling efficiency of the spot size converter 1 as compared with a comparative converter 100 formed by stacking a lower core layer 110 and an upper core layer 120 in the second direction Db.

The lower first core layer 60, the one-side second core layer 40, and the other-side second core layer 50 according to the present embodiment are stacked on the first cladding layer 11. The lower first core surface 65, the one-side second core surface 41, and the other-side second core surface 51 overlap in the second direction Db.

As described above, in the spot size converter 1 in which the lower first core surface 65, the one-side second core surface 41, and the other-side second core surface 51 overlap in the second direction Db, the lower first core layer 60, the one-side second core layer 40, and the other-side second core layer 50 can be provided on the same first cladding layer 11.

Regarding this, when the lower first core surface 65, the one-side second core surface 41, and the other-side second core surface 51 do not overlap in the second direction Db as in the fifth embodiment, the lower first core layer 60 is provided on the first cladding layer 11. Thereafter, it is necessary to provide the one-side second core layer 40 and the other-side second core layer 50 on the second cladding layer 12 different from the first cladding layer 11. In this case, in addition to a manufacturing process of forming the first cladding layer 11 for forming the lower first core layer 60, a manufacturing process of forming the second cladding layer 12 for forming the one-side second core layer 40 and the other-side second core layer 50 is required. Before forming the one-side second core layer 40 and the other-side second core layer 50, a manufacturing process of removing the second cladding layer 12 provided on the lower first core layer 60 is required.

However, according to the present embodiment, a fourth cladding layer 14 can be made unnecessary as compared with a case where the lower first core surface 65, the one-side second core surface 41, and the other-side second core surface 51 do not overlap in the second direction Db. Further, it is possible to reduce the manufacturing process of removing the second cladding layer 12 provided on the lower first core layer 60 before forming the one-side second core layer 40 and the other-side second core layer 50. Accordingly, a manufacturing process of manufacturing the spot size converter 1 can be simplified.

### Modification of Sixth Embodiment

In the sixth embodiment described above, a lower first core surface 65, a one-side second core surface 41, and the other-side second core surface 51 overlap in a second direction Db, but the present disclosure is not limited thereto. For example, the one-side second core surface 41 and the other-side second core surface 51 may overlap an upper first core surface 75 in the second direction Db.

Another first core layer 20 is provided between a lower first core layer 60 and an upper first core layer 70. In this case, the one-side second core surface 41 and the other-side second core surface 51 may overlap a first core surface 25 of the added first core layer 20 in the second direction Db.

### Seventh Embodiment

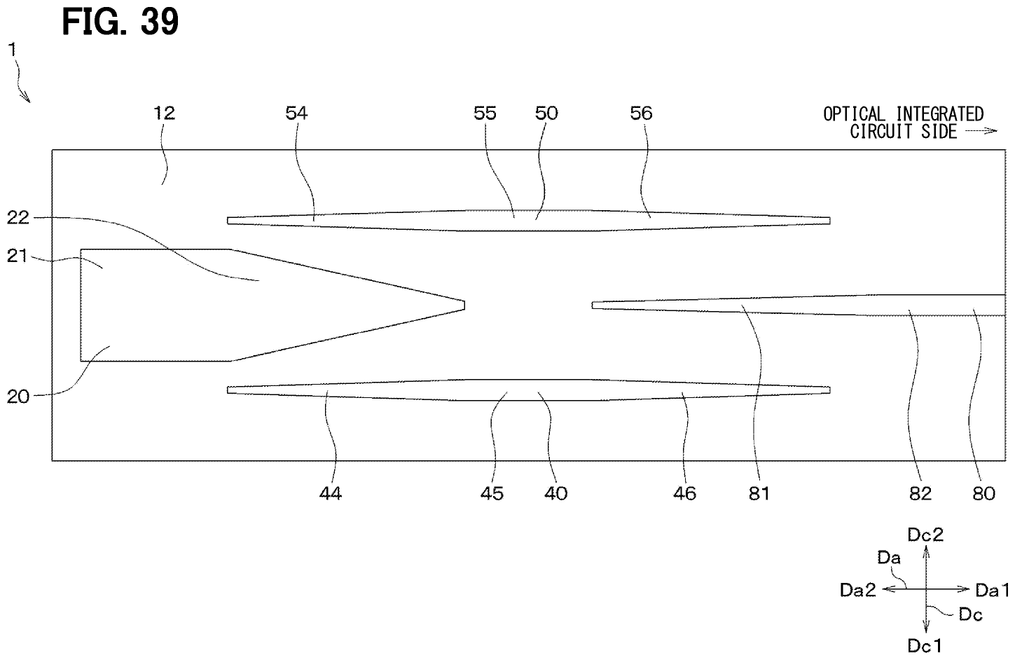

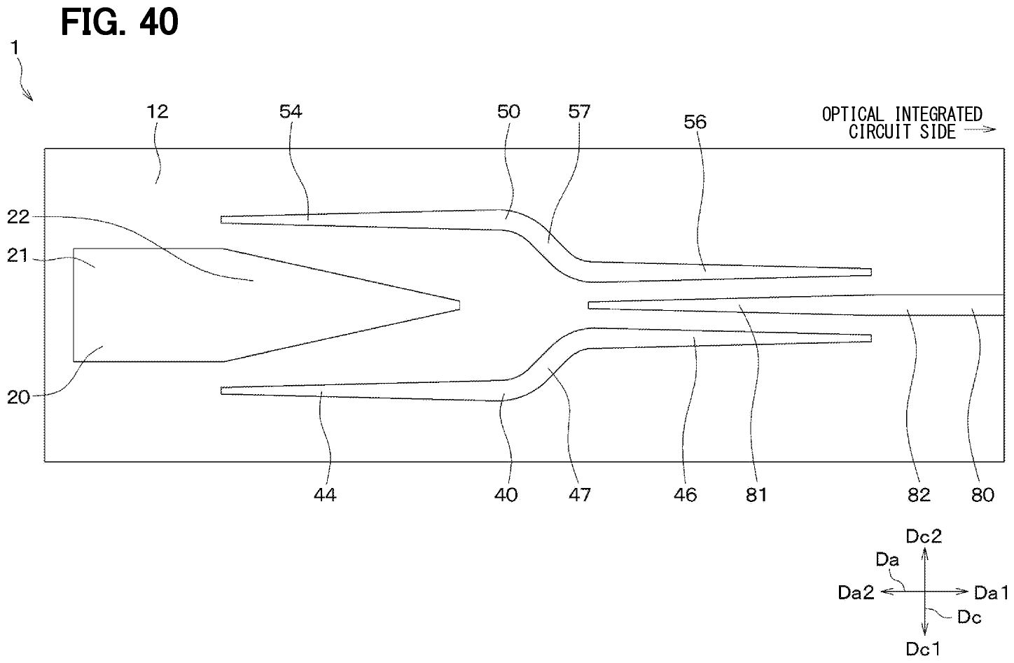

Next, a seventh embodiment will be described with reference to FIG. 39. The present embodiment is different from the third embodiment in that shapes of the one-side second core layer 40 and the other-side second core layer 50 are different and a third core layer 80 is provided. The other configuration is the same as that of the third embodiment. Therefore, in the present embodiment, portions different from the third embodiment will be mainly described, and description of portions similar to the third embodiment may be omitted.

The one-side second core layer 40 and the other-side second core layer 50 according to the present embodiment are different from those of the second embodiment in shapes of end portions in an emission direction Da1. Specifically, as shown in FIG. 39, the one-side second core layer 40 includes a one-side combining portion 46 on the end portion in the emission direction Da1. The other-side second core layer 50 includes the other-side combining portion 56 on the end portion in the emission direction Da1. The one-side combining portion 46 and the other-side combining portion 56 cause laser lights propagated through the one-side second core layer 40 and the other-side second core layer 50 to transition to the third core layer 80.

The one-side combining portion 46 and the other-side combining portion 56 have the same shape. Therefore, in the following description, only a shape of the one-side combining portion 46 will be described in detail, and detailed description of a shape of the other-side combining portion 56 will be omitted.

A size of the one-side combining portion 46 in a second direction Db from an end portion on an emission reverse direction Da2 side in a first direction Da to an end portion on the emission direction Da1 side is constant. In contrast, a size of the one-side combining portion 46 in a third direction Dc from the end portion on the emission reverse direction Da2 side in the first direction Da to the end portion on the emission direction Da1 side gradually decreases along the emission direction Da1.

Specifically, for the size of the one-side combining portion 46 in the third direction Dc, the size of the end portion on the emission reverse direction Da2 side is 1.0 μm, and the size of the end portion on the emission direction Da1 side is 0.2 μm. That is, the size of the end portion of the one-side combining portion 46, which is on the emission direction Da1 side, in the third direction Dc is the same as a size of an end portion of a one-side second tapered portion 44, which is on the emission reverse direction Da2 side, in the third direction Dc. The size of the one-side combining portion 46 in the third direction Dc from the end portion on the emission reverse direction Da2 side in the first direction Da to the end portion on the emission direction Da1 side continuously decreases.

For the one-side combining portion 46, the size of the end portion, which is on the emission direction Da1 side, in the third direction Dc is the smallest size that can be minimized in a manufacturing process to be used.

As shown in FIG. 39, the third core layer 80 is provided between the one-side second core layer 40 and the other-side second core layer 50 on a second cladding layer 12, and is spaced apart from the one-side second core layer 40 and the other-side second core layer 50. Specifically, the third core layer 80 is provided such that a distance between the third core layer 80 and the one-side second core layer 40 in the third direction Dc is equal to a distance between the third core layer 80 and the other-side second core layer 50 in the third direction Dc. A part of the third core layer 80 overlaps the one-side second core layer 40 and the other-side second core layer 50 in the third direction Dc.

The third core layer 80 extends along the first direction Da to an end portion of a spot size converter 1 in the emission direction Da1. The third core layer 80 is made of silicon nitride which is the same material as that of the one-side second core layer 40 and the other-side second core layer 50. The third core layer 80 functions as a waveguide path together with a first core layer 20, the one-side second core layer 40, and the other-side second core layer 50.

A size of the third core layer 80 in the second direction Db is the same as sizes of the one-side second core layer 40 and the other-side second core layer 50 in the second direction Db. Specifically, the size of the third core layer 80 in the second direction Db is 0.30 μm. The third core layer 80 is disposed to overlap positions of the one-side second core layer 40 and the other-side second core layer 50 in the second direction Db.

Therefore, similarly to a one-side second core surface 41 and the other-side second core surface 51, a surface of the third core layer 80 on a stacking reverse direction Db2 side does not overlap a first core surface 25 in the second direction Db, and is positioned on the stacking reverse direction Db2 side with respect to the first core surface 25.

The third core layer 80 includes a third tapered portion 81 and a third propagation portion 82. The third tapered portion 81 and the third propagation portion 82 are provided in this order along the emission direction Da1.

The third tapered portion 81 is a portion optically coupled to the one-side combining portion 46 and the other-side combining portion 56, and is a portion to which the laser light transitions from the one-side combining portion 46 and the other-side combining portion 56. The third tapered portion 81 is disposed on an end portion of the third core layer 80 on the emission reverse direction Da2 side in the first direction Da. The third tapered portion 81 is disposed between the one-side combining portion 46 of the one-side second core layer 40 and the other-side combining portion 56 of the other-side second core layer 50. The one-side combining portion 46 and the other-side combining portion 56 face each other in the third direction Dc.

A size of the third tapered portion 81 in the second direction Db from an end portion on the emission reverse direction Da2 side in the first direction Da to an end portion on the emission direction Da1 side is constant. In contrast, a size of the third tapered portion 81 in the third direction Dc from the end portion on the emission reverse direction Da2 side in the first direction Da to the end portion on the emission direction Da1 side gradually increases along the emission direction Da1. Specifically, for the size of the third tapered portion 81 in the third direction Dc, the size of the end portion on the emission reverse direction Da2 side is 0.2 μm, and the size of the end portion on the emission direction Da1 side is 1.0 μm. The size of the third tapered portion 81 in the third direction Dc from the end portion on the emission reverse direction Da2 side in the first direction Da to the end portion on the emission direction Da1 side continuously increases. That is, the third tapered portion 81 has the same shape as the one-side second tapered portion 44 and the other-side second tapered portion 54.

For the third tapered portion 81, the size of the end portion, which is on the emission reverse direction Da2 side, in the third direction Dc is the smallest size that can be minimized in the manufacturing process to be used.

At least a part of the third tapered portion 81 is provided at a position overlapping the one-side combining portion 46 and the other-side combining portion 56 in the third direction Dc. In the present embodiment, the entire third tapered portion 81 is provided at a position overlapping the one-side combining portion 46 and the other-side combining portion 56 in the third direction Dc. That is, the size of the third tapered portion 81 in the first direction Da is equal to the sizes of the one-side combining portion 46 and the other-side combining portion 56 in the first direction Da.

Therefore, the position of the end portion of the third tapered portion 81, which is on the emission reverse direction Da2 side, in the first direction Da matches the positions of the end portions of the one-side combining portion 46 and the other-side combining portion 56, which are on the emission reverse direction Da2 side, in the first direction Da. The position of the end portion of the third tapered portion 81, which is on the emission direction Da1 side, in the first direction Da matches the positions of the end portions of the one-side combining portion 46 and the other-side combining portion 56, which are on the emission direction Da1 side, in the first direction Da.

In the spot size converter 1, the size of the third tapered portion 81 in the third direction Dc gradually increases along the emission direction Da1 while the sizes of the one-side combining portion 46 and the other-side combining portion 56 in the third direction Dc gradually decrease along the emission direction Da1. The one-side combining portion 46, the other-side combining portion 56, and the third tapered portion 81 function as a waveguide path in the spot size converter 1.

Therefore, in the spot size converter 1, a cross-sectional area of the waveguide path orthogonal to the emission direction Da1 at the one-side combining portion 46 and the other-side combining portion 56 functioning as the waveguide path gradually decreases along the emission direction Da1. In contrast, in the spot size converter 1, a cross-sectional area of the waveguide path orthogonal to the emission direction Da1 at the third tapered portion 81 functioning as the waveguide path gradually increases along the emission direction Da1.

Accordingly, among the waveguide paths in the spot size converter 1, a cross-sectional area of the waveguide path orthogonal to the emission direction Da1 at a portion formed by the one-side combining portion 46, the other-side combining portion 56, and the third tapered portion 81 is less likely to change along the emission direction Da1. The third tapered portion 81 is connected to the third propagation portion 82 on the emission direction Da1 side. The third tapered portion 81 corresponds to a combined facing portion.

The third propagation portion 82 is a portion optically coupled to a circuit waveguide path CW, and guides the laser light propagated from an optical fiber waveguide path FW to the circuit waveguide path CW. A size of the third propagation portion 82 in the second direction Db and a size of the third propagation portion 82 in the third direction Dc from a one side end portion to the other side end portion in the first direction Da are constant. Specifically, the size of the third propagation portion 82 in the second direction Db is 0.30 μm and the size of the third propagation portion 82 in the third direction Dc is 1.0 μ. The third propagation portion 82 is provided on the emission direction Da1 side with respect to the one-side second core layer 40 and the other-side second core layer 50. That is, the third propagation portion 82 is provided at a position not overlapping the one-side second core layer 40 and the other-side second core layer 50 in the third direction Dc.

In manufacturing of the spot size converter 1 according to the present embodiment, first, the first cladding layer 11 is formed on a substrate (not shown). Then, the one-side second core layer 40, the other-side second core layer 50, and the third core layer 80 are formed on the first cladding layer 11 by patterning. Thereafter, the second cladding layer 12 is formed on the one-side second core layer 40, on the other-side second core layer 50, on the third core layer 80, and on portions of the first cladding layer 11 on which the one-side second core layer 40, the other-side second core layer 50, and the third core layer 80 are not formed. Then, the second cladding layer 12 formed on the one-side second core layer 40, the other-side second core layer 50, and the third core layer 80 is removed by, for example, CMP.

Thereafter, the first core layer 20 is formed on the second cladding layer 12 by patterning. A third cladding layer 13 is formed on the first core layer 20, the one-side second core layer 40, the other-side second core layer 50, the third core layer 80, and portions of the second cladding layer 12 on which the first core layer 20, the one-side second core layer 40, the other-side second core layer 50, and the third core layer 80 are not formed. Accordingly, the first core layer 20, the one-side second core layer 40, the other-side second core layer 50, and the third core layer 80 are covered with the third cladding layer 13.

Thereafter, unnecessary portions of the third cladding layer 13 formed on the first core layer 20, the one-side second core layer 40, the other-side second core layer 50, and third core layer 80 are removed by, for example, CMP. Accordingly, the spot size converter 1 in which the first cladding layer 11 to the third cladding layer 13, the first core layer 20, the one-side second core layer 40, the other-side second core layer 50, and the third core layer 80 are provided on the substrate (not shown) is manufactured.

Next, an operation of the spot size converter 1 according to the present embodiment will be described. In the spot size converter 1 according to the present embodiment, when the laser light is propagated from the optical fiber waveguide path FW to the first core layer 20, the laser light is propagated to the first tapered portion 22. Then, the laser light propagated to the first tapered portion 22 gradually transitions to the one-side second tapered portion 44 and the other-side second tapered portion 54.

The laser light that has transitioned to the one-side second tapered portion 44 is propagated from the one-side second tapered portion 44 to the one-side combining portion 46 via a one-side second propagation portion 45. The laser light that has transitioned to the other-side second tapered portion 54 is propagated from the other-side second tapered portion 54 to the other-side combining portion 56 via the other-side second propagation portion 55.

The sizes of the one-side combining portion 46 and the other-side combining portion 56 in the third direction Dc decrease along the emission direction Da1. Therefore, in the one-side combining portion 46 and the other-side combining portion 56, optical confinement when the laser light is propagated is gradually weakened along the emission direction Da1. That is, an optical confinement coefficient of the one-side combining portion 46 and the other-side combining portion 56 gradually decreases along the emission direction Da1. Therefore, the laser light propagated through the one-side combining portion 46 and the other-side combining portion 56 gradually transitions to the third tapered portion 81.

The third core layer 80 is provided such that a distance between the third core layer 80 and the one-side second core layer 40 in the third direction Dc is equal to a distance between the third core layer 80 and the other-side second core layer 50 in the third direction Dc. Therefore, the laser lights propagated from the one-side combining portion 46 and the other-side combining portion 56 to the third tapered portion 81 transition in a state where phases thereof are substantially aligned.

The laser lights that have transitioned from the one-side combining portion 46 and the other-side combining portion 56 to the third tapered portion 81 are combined in the third tapered portion 81, and are propagated from the third tapered portion 81 to the third propagation portion 82. The laser light propagated to the third propagation portion 82 is propagated through the third propagation portion 82 along the emission direction Da1 and is propagated to the circuit waveguide path CW. As described above, the one-side combining portion 46, the other-side combining portion 56, and the third tapered portion 81 according to the present embodiment function as a light combining portion that combines the laser lights propagated through the one-side second core layer 40 and the other-side second core layer 50.

Accordingly, the spot size converter 1 can combine and output the laser lights that are divided and propagated from the first core layer 20 to the one-side second core layer 40 and the other-side second core layer 50. Therefore, it is possible to eliminate the need to use an optical combiner for combining the two divided laser lights, which is separately from the spot size converter 1.

In the third core layer 80, it is possible to combine the laser lights propagated through the one-side second core layer 40 and the other-side second core layer 50. Thus, the light combining portion can be implemented with a simple configuration.

According to the above embodiment, the following effects can be obtained.

(1) In the above embodiment, the size of the third tapered portion 81 in the third direction Dc increases along the emission direction Da1.

Accordingly, immediately before and immediately after the laser light passes through the end portion of the third core layer 80 on the emission reverse direction Da2 side, a change in a cross-sectional shape of the waveguide path orthogonal to the emission direction Da1 can be limited, as compared with a case where such a configuration is not formed.

Therefore, when the laser light transitions from the one-side second core layer 40 and the other-side second core layer 50 to the third core layer 80, a change in an electric field intensity distribution of the laser light due to the rapid change in the cross-sectional area of the waveguide path can be limited. Accordingly, it is possible to reduce deterioration of transmission efficiency when the laser light transitions from the one-side second core layer 40 and the other-side second core layer 50 to the third core layer 80. Accordingly, the coupling efficiency of the spot size converter 1 can be improved.

### First Modification of Seventh Embodiment

In the seventh embodiment described above, an example in which a surface of a third core layer 80 on a stacking reverse direction Db2 side does not overlap a first core surface 25 in a second direction Db and is positioned on the stacking reverse direction Db2 side with respect to the first core surface 25 has been described, but the present disclosure is not limited thereto. For example, the surface of the third core layer 80 on the stacking reverse direction Db2 side may overlap the first core surface 25 in the second direction Db, similarly to a one-side second core surface 41 and the other-side second core surface 51 according to the fourth embodiment.

Accordingly, a third cladding layer 13 can be made unnecessary, and a manufacturing process of removing a cladding layer can be reduced. Accordingly, a manufacturing process of manufacturing the spot size converter 1 can be simplified.

### Second Modification of Seventh Embodiment

In the seventh embodiment described above, an example in which one first core layer 20 is provided has been described, but the present disclosure is not limited thereto. For example, a spot size converter 1 may include a lower first core layer 60 and an upper first core layer 70 as described in the fifth embodiment and the sixth embodiment.

In this case, a surface of a third core layer 80 on a stacking reverse direction Db2 side may not overlap a lower first core surface 65 in a second direction Db, similarly to a one-side second core surface 41 and the other-side second core surface 51 according to the fifth embodiment. That is, the surface of the third core layer 80 on the stacking reverse direction Db2 side may be positioned on the stacking reverse direction Db2 side with respect to the lower first core surface 65. The surface of the third core layer 80 on the stacking reverse direction Db2 side may overlap the lower first core surface 65 in the second direction Db, similarly to the one-side second core surface 41 and the other-side second core surface 51 according to the sixth embodiment.

### Eighth Embodiment

Next, an eighth embodiment will be described with reference to FIG. 40. The present embodiment is different from the seventh embodiment in shapes of a one-side second core layer 40 and the other-side second core layer 50. The other configuration is the same as that of the seventh embodiment. Therefore, in the present embodiment, portions different from the seventh embodiment will be mainly described, and description of portions similar to the seventh embodiment may be omitted.

As shown in FIG. 40, the one-side second core layer 40 according to the present embodiment is different from that of the seventh embodiment in that a one-side second propagation portion 45 is eliminated and a one-side inner bent portion 47 is provided instead of the one-side second propagation portion 45. The other-side second core layer 50 according to the present embodiment is different from that of the seventh embodiment in that the other-side second propagation portion 55 is eliminated, and the other-side inner bent portion 57 is provided instead of the other-side second propagation portion 55.

The one-side inner bent portion 47 is connected to a one-side second tapered portion 44 on an emission reverse direction Da2 side, and is connected to a one-side combining portion 46 on an emission direction Da1 side. That is, the one-side inner bent portion 47 is provided on the emission reverse direction Da2 side with respect to the one-side combining portion 46. The one-side inner bent portion 47 connects the one-side second tapered portion 44 and the one-side combining portion 46. The one-side inner bent portion 47 is disposed at a position not overlapping the one-side second tapered portion 44 and the one-side combining portion 46 in a third direction Dc.

The one-side inner bent portion 47 is bent to approach a third tapered portion 81. Accordingly, the one-side combining portion 46 is brought closer to the third tapered portion 81 by the one-side inner bent portion 47. That is, the one-side inner bent portion 47 reduces sizes of the one-side combining portion 46 and the third tapered portion 81 in the third direction Dc.

Specifically, the one-side inner bent portion 47 is bent such that the sizes of the one-side combining portion 46 and the third tapered portion 81 in the third direction Dc are ½ or less compared to a configuration not including the one-side inner bent portion 47. The one-side inner bent portion 47 is formed to have the same size in a second direction Db as the sizes of the one-side second tapered portion 44 and the one-side combining portion 46 in the second direction Db.

The other-side inner bent portion 57 is connected to the other-side second tapered portion 54 on the emission reverse direction Da2 side, and is connected to the other-side combining portion 56 on the emission direction Da1 side. That is, the other-side inner bent portion 57 is provided on the emission reverse direction Da2 side with respect to the other-side combining portion 56. The other-side inner bent portion 57 connects the other-side second tapered portion 54 and the other-side combining portion 56. The other-side inner bent portion 57 is disposed at a position not overlapping the other-side second tapered portion 54 and the other-side combining portion 56 in the third direction Dc.

The other-side inner bent portion 57 is bent to approach the third tapered portion 81. Accordingly, the other-side combining portion 56 is brought closer to the third tapered portion 81 by the other-side inner bent portion 57. That is, the other-side inner bent portion 57 reduces sizes of the other-side combining portion 56 and the third tapered portion 81 in the third direction Dc.

Specifically, the other-side inner bent portion 57 is bent such that the sizes of the other-side combining portion 56 and the third tapered portion 81 in the third direction Dc are ½ or less compared to a configuration not including the other-side inner bent portion 57. The other-side inner bent portion 57 is formed to have the same size in the second direction Db as the sizes of the other-side second tapered portion 54 and the other-side combining portion 56 in the second direction Db.

In the present embodiment, the one-side inner bent portion 47 and the other-side inner bent portion 57 are provided such that a size of the one-side combining portion 46 and the third tapered portion 81 in the third direction Dc is the same as a size of the other-side combining portion 56 and the third tapered portion 81 in the third direction Dc.

Accordingly, by bringing the one-side combining portion 46 close to the third tapered portion 81, a laser light can be easily transitioned when the laser light transitions from the one-side combining portion 46 to the third tapered portion 81. By bringing the other-side combining portion 56 close to the third tapered portion 81, the laser light can be easily transitioned when the laser light transitions from the other-side combining portion 56 to the third tapered portion 81.

Therefore, it is possible to reduce loss of light transition occurring when the laser light transitions from the one-side combining portion 46 to the third tapered portion 81, and it is possible to reduce loss of light transition occurring when the laser light transitions from the other-side combining portion 56 to the third tapered portion 81.

Even when a size of the one-side combining portion 46 in a first direction Da is reduced as compared with the configuration in which the one-side inner bent portion 47 is not provided, the laser light can sufficiently transition from the one-side combining portion 46 to the third tapered portion 81. Even when a size of the other-side combining portion 56 in the first direction Da is reduced as compared with the configuration in which the other-side inner bent portion 57 is not provided, the laser light can sufficiently transition from the other-side combining portion 56 to the third tapered portion 81. Therefore, a size of the spot size converter 1 in the first direction Da can be reduced, and a size of a housing of the spot size converter 1 can be reduced.

### Ninth Embodiment

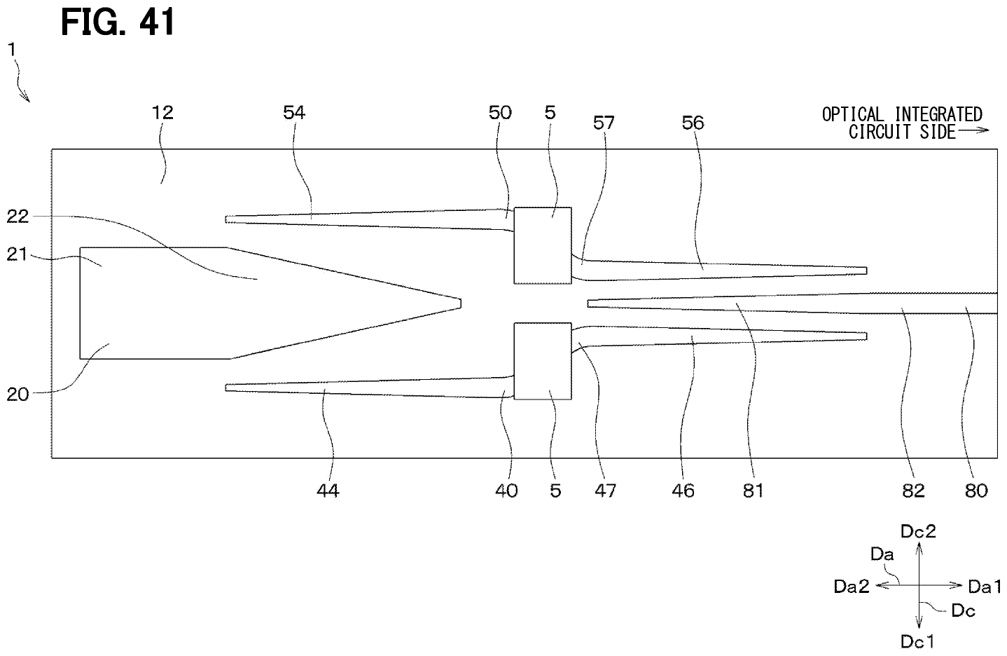

Next, a ninth embodiment will be described with reference to FIG. 41. The present embodiment is different from the eighth embodiment in that heaters 5 are provided in a one-side second core layer 40 and the other-side second core layer 50. The other configuration is the same as that of the eighth embodiment. Therefore, in the present embodiment, portions different from the eighth embodiment will be mainly described, and description of portions similar to the eighth embodiment may be omitted.

As shown in FIG. 41, the heaters 5 are respectively provided in the one-side second core layer 40 and the other-side second core layer 50 according to the present embodiment. Specifically, one heater 5 is provided in a one-side inner bent portion 47 on an emission reverse direction Da2 side with respect to a one-side combining portion 46 in the one-side second core layer 40. The other heater 5 is provided in the other-side inner bent portion 57 on the emission reverse direction Da2 side with respect to the other-side combining portion 56 in the other-side second core layer 50.

The heaters 5 are connected to a control device (not shown), and a heating temperature (that is, heating capacity) is controlled by a control signal from the control device. The heater 5 provided in the one-side second core layer 40 changes, by heating the one-side second core layer 40 and adjusting a temperature of the one-side second core layer 40, a phase of a laser light propagated through the one-side second core layer 40. The heater 5 provided in the other-side second core layer 50 changes, by heating the other-side second core layer 50 and adjusting a temperature of the other-side second core layer 50, a phase of a laser light propagated through the other-side second core layer 50. The heaters 5 according to the present embodiment function as a phase adjustment unit that adjusts the phase of the laser light propagated through the one-side second core layer 40 and the other-side second core layer 50.

The heater 5 provided in the one-side second core layer 40 may be provided, for example, in a one-side second tapered portion 44 as long as the heater 5 is provided on the emission reverse direction Da2 side with respect to the one-side combining portion 46 in the one-side second core layer 40. The heater 5 provided in the other-side second core layer 50 may be provided, for example, in the other-side second tapered portion 54 as long as the heater 5 is provided on the emission reverse direction Da2 side with respect to the other-side combining portion 56 in the other-side second core layer 50.

As described above, a reason why the heaters 5 are provided in the one-side second core layer 40 and the other-side second core layer 50 will be described below.

In the one-side second core layer 40, the laser light transitions from a first core layer 20 to the one-side second tapered portion 44. In the other-side second core layer 50, the laser light also transitions from the first core layer 20 to the other-side second tapered portion 54. A distance in a third direction Dc between the one-side second core layer 40 and the first core layer 20 is equal to a distance in the third direction Dc between the other-side second core layer 50 and the first core layer 20.

In this case, the laser lights, which transition from the first core layer 20 to the one-side second tapered portion 44 and the other-side second tapered portion 54, transition in a state where the phases thereof are aligned with each other. The laser lights that have transitioned to the one-side second tapered portion 44 and the other-side second tapered portion 54 are propagated in a spot size converter 1 in a state where the phases thereof are aligned, and are combined in a third tapered portion 81. Therefore, an output of the laser light combined by the third tapered portion 81 is larger than that of the laser light combined in a state where the phases are not aligned. Therefore, it is desirable that the distance in the third direction Dc between the one-side second core layer 40 and the first core layer 20 and the distance in the third direction Dc between the other-side second core layer 50 and the first core layer 20 are equal to each other.

However, the distance in the third direction Dc between the one-side second core layer 40 and the first core layer 20 and the distance in the third direction Dc between the other-side second core layer 50 and the first core layer 20 may be different from each other due to factors such as a manufacturing error. In this case, it is assumed that the laser lights that transition from the first core layer 20 to the one-side second tapered portion 44 and the other-side second tapered portion 54 transition in a state where the phases are shifted from each other. Therefore, the laser lights that have transitioned to the one-side second tapered portion 44 and the other-side second tapered portion 54 are propagated in the spot size converter 1 in a state where the phases are shifted, and are combined in the third tapered portion 81. As a result, the output of the laser light combined by the third tapered portion 81 is smaller than that of the laser light combined in a state where the phases are aligned. The above causes a decrease in the output of the laser light output from the spot size converter 1.

However, in the spot size converter 1 according to the present embodiment, the heaters 5 are provided in the one-side second core layer 40 and the other-side second core layer 50. The heaters 5 heat the one-side second core layer 40 and the other-side second core layer 50 to adjust the phases of the laser lights propagated through the one-side second core layer 40 and the other-side second core layer 50.

Accordingly, it is possible to limit phase shift caused by a difference between the distance in the third direction Dc between the one-side second core layer 40 and the first core layer 20 and the distance in the third direction Dc between the other-side second core layer 50 and the first core layer 20. It is possible to limit a decrease in the output of the laser light combined by the third tapered portion 81 due to the phase shift. That is, compared to a configuration in which the heater 5 is not provided, the output of the laser light output from the spot size converter 1 can be increased.

The heating capacity of the heaters 5 provided in the one-side second core layer 40 and the other-side second core layer 50 may be adjusted based on a magnitude of the laser light output from the spot size converter 1.

According to the above embodiment, the following effects can be obtained.

(1) In the above embodiment, the phase adjustment unit is formed by the heaters 5 that heat the one-side second core layer 40 and the other-side second core layer 50.

Accordingly, the phase adjustment unit can be implemented with a simple configuration.

### Modification of Ninth Embodiment

In the ninth embodiment described above, heater 5 are provided in a one-side second core layer 40 and the other-side second core layer 50, but the present disclosure is not limited thereto. For example, the heater 5 may be provided in only one of the one-side second core layer 40 and the other-side second core layer 50.

For example, when the heater 5 is provided only in the one-side second core layer 40, the one-side second core layer 40 can be heated by the heater 5. A phase of a laser light propagated through the one-side second core layer 40 can be adjusted to be aligned with a phase of a laser light propagated through the other-side second core layer 50.

### Tenth Embodiment

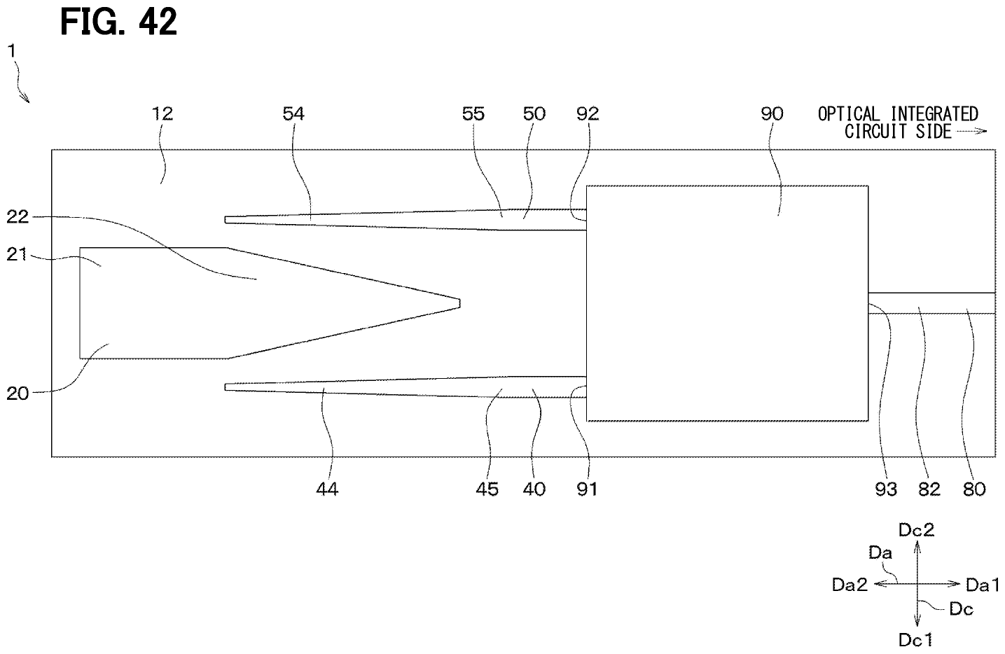

Next, a tenth embodiment will be described with reference to FIG. 42. In the present embodiment, compared to the seventh embodiment, a one-side combining portion 46 is eliminated from a one-side second core layer 40, the other-side combining portion 56 is eliminated from the other-side second core layer 50, and a third tapered portion 81 is eliminated from a third core layer 80. The present embodiment is different from the seventh embodiment in that a multi-mode interference device 90 is provided instead of the eliminated one-side combining portion 46, other-side combining portion 56, and third tapered portion 81. The other configuration is the same as that of the seventh embodiment. Therefore, in the present embodiment, portions different from the seventh embodiment will be mainly described, and description of portions similar to the seventh embodiment may be omitted.

As shown in FIG. 42, a spot size converter 1 according to the present embodiment includes the multi-mode interference device 90. The multi-mode interference device 90 combines a laser light propagated through the one-side second core layer 40 and a laser light propagated through the other-side second core layer 50, and is also referred to as a multi-mode interference (MMI) device.

The multi-mode interference device 90 is provided between the one-side second core layer 40 and the third core layer 80 in a first direction Da. The multi-mode interference device 90 is provided between the other-side second core layer 50 and the third core layer 80 in the first direction Da.

In the multi-mode interference device 90, end portions of the one-side second core layer 40 and the other-side second core layer 50 in an emission direction Da1 are connected to each other. Specifically, the multi-mode interference device 90 includes a one-side input unit 91 on a one-side third direction Dc1 side and the other-side input unit 92 on the other-side third direction Dc2 side in an emission reverse direction Da2. The one-side second core layer 40 is connected to the one-side input unit 91. The other-side second core layer 50 is connected to the other-side input unit 92.

The multi-mode interference device 90 has an output side connected to an end portion of the third core layer 80 in the emission reverse direction Da2. Specifically, the multi-mode interference device 90 includes an output unit 93 substantially at a center in a third direction Dc on the emission direction Da1 side. The third core layer 80 is connected to the output unit 93.

Next, an operation of the spot size converter 1 according to the present embodiment will be described. In the spot size converter 1 according to the present embodiment, when the laser light is propagated from the optical fiber waveguide path FW to the first core layer 20, the laser light is propagated to the first tapered portion 22. Then, the laser light propagated to the first tapered portion 22 gradually transitions to a one-side second tapered portion 44 and the other-side second tapered portion 54.

The laser light that has transitioned to the one-side second tapered portion 44 is propagated from the one-side second tapered portion 44 to the one-side input unit 91 of the multi-mode interference device 90 via a one-side second propagation portion 45. The laser light that has transitioned to the other-side second tapered portion 54 is propagated from the other-side second tapered portion 54 to the other-side input unit 92 of the multi-mode interference device 90 via the other-side second propagation portion 55.

The laser lights received from the one-side second propagation portion 45 and the other-side second propagation portion 55 to the multi-mode interference device 90 are combined in the multi-mode interference device 90 and output from the output unit 93. The laser light output from the output unit 93 of the multi-mode interference device 90 is propagated to a circuit waveguide path CW via the third core layer 80. As described above, the multi-mode interference device 90 according to the present embodiment functions as a light combining portion that combines the laser lights propagated through the one-side second core layer 40 and the other-side second core layer 50.

Accordingly, the spot size converter 1 can combine and output the laser lights that are divided and propagated from the first core layer 20 to the one-side second core layer 40 and the other-side second core layer 50. Therefore, it is possible to eliminate the need to use an optical combiner for combining the two divided laser lights, which is separately from the spot size converter 1.

Compared to the seventh embodiment, the one-side combining portion 46 of the one-side second core layer 40, the other-side combining portion 56 of the other-side second core layer 50, and the third tapered portion 81 of the third core layer 80 can be made unnecessary.

The one-side combining portion 46 and the other-side combining portion 56 need to have a shape in which a size in the third direction Dc gradually decreases along the emission direction Da1 by being formed to weaken optical confinement along the emission direction Da1. Therefore, the one-side second core layer 40 and the other-side second core layer 50 need to secure a size in the first direction Da for forming the one-side combining portion 46 and the other-side combining portion 56.

Regarding this, in the embodiment in which the light combining portion is formed by the multi-mode interference device 90, it is not necessary to secure the size in the first direction Da for forming the one-side combining portion 46 in the one-side second core layer 40 and the other-side combining portion 56 in the other-side second core layer 50. It is not necessary to secure a size in the first direction Da for forming the third tapered portion 81 in the third core layer 80.

Accordingly, a size of the spot size converter 1 in the first direction Da can be reduced as compared with a case in which the one-side combining portion 46, the other-side combining portion 56, and the third tapered portion 81 form the light combining portion. It is possible to reduce a size of a housing of the spot size converter 1.

### Eleventh Embodiment

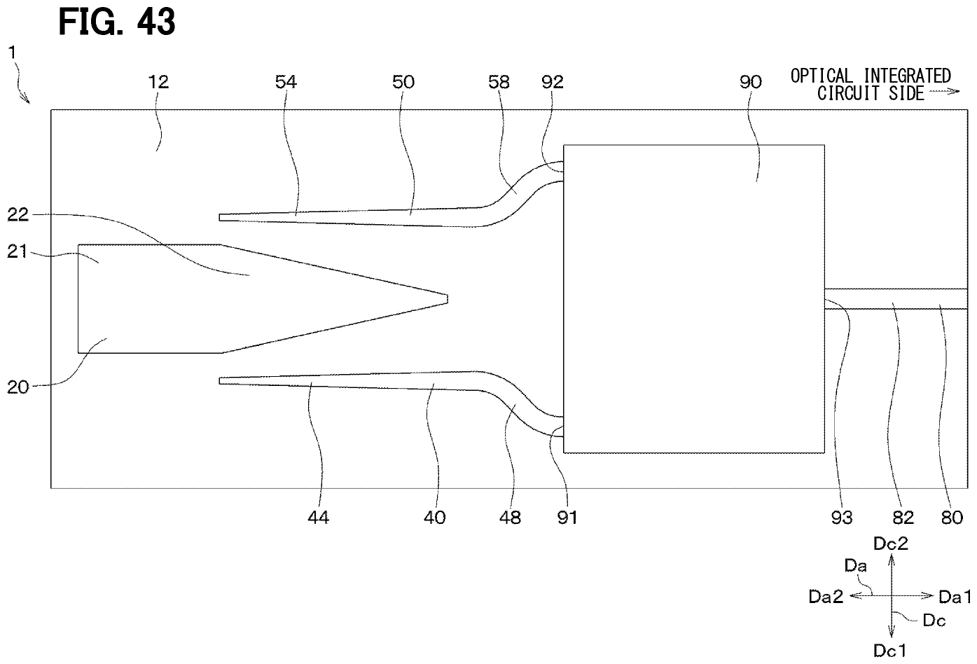

Next, an eleventh embodiment will be described with reference to FIG. 43. The present embodiment is different from the tenth embodiment in shapes of a one-side second core layer 40 and the other-side second core layer 50. The other configuration is the same as that of the tenth embodiment. Therefore, in the present embodiment, portions different from the tenth embodiment will be mainly described, and description of portions similar to the tenth embodiment may be omitted.

As shown in FIG. 43, the one-side second core layer 40 according to the present embodiment is different from that of the tenth embodiment in that a one-side second propagation portion 45 is eliminated and a one-side outer bent portion 48 is provided instead of the one-side second propagation portion 45. The other-side second core layer 50 according to the present embodiment is different from that of the tenth embodiment in that the other-side second propagation portion 55 is eliminated, and the other-side outer bent portion 58 is provided instead of the other-side second propagation portion 55.

The one-side outer bent portion 48 is connected to a one-side second tapered portion 44 on an emission reverse direction Da2 side, and is connected to a multi-mode interference device 90 on an emission direction Da1 side. That is, the one-side outer bent portion 48 is provided on the emission reverse direction Da2 side with respect to a portion of the one-side second core layer 40 to which the multi-mode interference device 90 is connected. The one-side outer bent portion 48 connects the one-side second tapered portion 44 and the multi-mode interference device 90. The one-side outer bent portion 48 is disposed at a position not overlapping the one-side second tapered portion 44 in a third direction Dc. The one-side outer bent portion 48 is bent away from the other-side second core layer 50.

The other-side outer bent portion 58 is connected to the other-side second tapered portion 54 on the emission reverse direction Da2 side, and is connected to the multi-mode interference device 90 on the emission direction Da1 side. That is, the other-side outer bent portion 58 is provided on the emission reverse direction Da2 side with respect to a portion of the other-side second core layer 50 to which the multi-mode interference device 90 is connected. The other-side outer bent portion 58 connects the other-side second tapered portion 54 and the multi-mode interference device 90. The other-side outer bent portion 58 is disposed at a position not overlapping the other-side second tapered portion 54 in the third direction Dc. The other-side outer bent portion 58 is bent away from the one-side second tapered portion 44.

Accordingly, the multi-mode interference device 90 can increase an interval between a one-side input unit 91 and the other-side input unit 92 as compared with a configuration in which the one-side outer bent portion 48 and the other-side outer bent portion 58 are not provided. That is, the one-side outer bent portion 48 and the other-side outer bent portion 58 increase the interval between the one-side input unit 91 and the other-side input unit 92.

Specifically, the one-side outer bent portion 48 and the other-side outer bent portion 58 are bent such that the interval between the one-side input unit 91 and the other-side input unit 92 is 1.5 times or more as compared with the configuration in which the one-side outer bent portion 48 and the other-side outer bent portion 58 are not provided.

In the present embodiment, the one-side outer bent portion 48 and the other-side outer bent portion 58 are provided such that a distance between a center of the multi-mode interference device 90 in the third direction Dc and the one-side input unit 91 is equal to a distance between the center of the multi-mode interference device 90 in the third direction Dc and the other-side input unit 92.

When multiple laser lights are input to the multi-mode interference device 90 and combined, as an interval between portions of the multi-mode interference device 90 to which the laser lights are input is larger, loss when the multi-mode interference device 90 combines the lights is smaller. According to the present embodiment, it is possible to increase the interval in the third direction Dc between the one-side input unit 91 and the other-side input unit 92 of the multi-mode interference device 90 to which the laser light is input, as compared with the configuration in which the one-side outer bent portion 48 and the other-side outer bent portion 58 are not provided. Accordingly, it is possible to reduce the loss occurs when the laser lights propagated from the one-side second core layer 40 and the other-side second core layer 50 are combined in the multi-mode interference device 90.

### Modification of Eleventh Embodiment

In the tenth embodiment described above, unlike the ninth embodiment, heaters 5 are not provided in a one-side second core layer 40 and the other-side second core layer 50, but the present disclosure is not limited thereto. For example, as in the ninth embodiment, at least one of the one-side second core layer 40 and the other-side second core layer 50 may be provided with the heater 5. When the heater 5 is provided in the one-side second core layer 40, the heater 5 may be provided in either a one-side outer bent portion 48 or a one-side second tapered portion 44. When the heater 5 is provided in the other-side second core layer 50, the heater 5 may be provided in either the other-side outer bent portion 58 or the other-side second tapered portion 54.

### Other Embodiments

Although representative embodiments according to the present disclosure are described above, the present disclosure is not limited to the above-described embodiments, and various modifications can be made, for example, as follows.

In the embodiment described above, an example in which a spot size converter 1 narrows an electric field intensity distribution when a laser light is emitted from an optical fiber F has been described, but the present disclosure is not limited thereto. For example, when a waveguide path connected to an input side of the spot size converter 1 is smaller than a waveguide path connected to an output side, in the spot size converter 1, the smaller waveguide path is connected to a second core layer 30 and the larger waveguide path is connected to a first core layer 20. In this case, the spot size converter 1 can expand the electric field intensity distribution with respect to an electric field intensity distribution when the laser light is input, and the laser light can be emitted.

In the embodiment described above, a size of the first core layer 20 on an emission reverse direction Da2 side in a third direction Dc is 2.0 μm or 3.5 μm, and a size of the first core layer 20 on an emission direction Da1 side in the third direction Dc is 0.2 μm. An example in which a size of a first tapered portion 22 of the first core layer 20 in a first direction Da is 1000 μm and a size of the first tapered portion 22 in a second direction Db is 0.050 μm or 0.025 μm has been described.

An example in which a size of the second core layer 30 on the emission reverse direction Da2 side in the third direction Dc is 0.2 μm and a size of the second core layer 30 on the emission direction Da1 side in the third direction Dc is 1.0 μm has been described. An example in which a size of a second tapered portion 34 of the second core layer 30 in the first direction Da is 1000 μm and a size of the second tapered portion 34 in the second direction Db is 0.30 μm has been described.

However, the sizes of the first core layer 20 and the second core layer 30 in the first direction Da, the second direction Db, and the third direction Dc can be appropriately changed according to a size of an optical fiber waveguide path FW of the optical fiber F, a size of a circuit waveguide path CW of an optical integrated circuit C, and the like.

In the embodiment described above, an example in which the first tapered portion 22 is disposed at an end portion of the first core layer 20 in the emission direction Da1 has been described. An example in which the second tapered portion 34 is disposed at an end portion of the second core layer 30 in the emission reverse direction Da2 has been described. However, an arrangement of the first tapered portion 22 and the second tapered portion 34 is not limited thereto.

For example, the first tapered portion 22 may not be disposed at the end portion of the first core layer 20 in the emission direction Da1. In this case, the first core layer 20 may have a portion extending in the first direction Da, the portion having a size in the third direction Dc on the emission direction Da1 side of the first tapered portion 22 the same as a size of an end portion of the first tapered portion 22, which is on the emission direction Da1 side, in the third direction Dc.

The second tapered portion 34 may not be disposed at the end portion of the second core layer 30 in the emission reverse direction Da2. In this case, the second core layer 30 may have a portion extending in the first direction Da, the portion having a size in the third direction Dc on the emission reverse direction Da2 side of the second tapered portion 34 the same as a size of an end portion of the second tapered portion 34, which is on the emission reverse direction Da2 side, in the third direction Dc.

In the embodiment described above, an example in which the size of the end portion of the second core layer 30, which is on the emission reverse direction Da2 side, in the third direction Dc is smaller than the size in the second direction Db has been described, but the present disclosure is not limited thereto. For example, the second core layer 30 may be provided such that the size of the end portion, which is on the emission reverse direction Da2 side, in the third direction Dc is larger than the size in the second direction Db.

In the embodiment described above, an example in which an absolute value of variation of the first tapered portion 22 in the third direction Dc per unit length in the emission direction Da1 is larger than an absolute value of variation of the second tapered portion 34 in the third direction Dc per unit length in the emission direction Da1 has been described, but the present disclosure is not limited thereto. For example, the absolute value of the variation of the first tapered portion 22 in the third direction Dc per unit length in the emission direction Da1 may be larger than the absolute value of the variation of the second tapered portion 34 in the third direction Dc per unit length in the emission direction Da1.

In the embodiment described above, an example in which a position of the end portion of the first tapered portion 22, which is on the emission reverse direction Da2 side, in the first direction Da matches a position of the end portion of the second tapered portion 34, which is on the emission reverse direction Da2 side, in the first direction Da has been described, but the present disclosure is not limited thereto. For example, the position of the end portion of the first tapered portion 22, which is on the emission reverse direction Da2 side, in the first direction Da may not match the position of the end portion of the second tapered portion 34, which is on the emission reverse direction Da2 side, in the first direction Da.

In the embodiment described above, an example in which a position of the end portion of the first tapered portion 22 in the emission direction Da1 in the first direction Da matches a position of the end portion of the second tapered portion 34 in the emission direction Da1 in the first direction Da has been described, but the present disclosure is not limited thereto. For example, the position of the end portion of the first tapered portion 22 in the emission direction Da1 in the first direction Da may not match the position of the end portion of the second tapered portion 34 in the emission direction Da1 in the first direction Da.

In the embodiment described above, the first core layer 20 and the second core layer 30 are made of silicon nitride. Although an example has been described, the present disclosure is not limited thereto. For example, the first core layer 20 and the second core layer 30 may include a member different from silicon nitride as long as silicon nitride is contained. The first core layer 20 and the second core layer 30 may not contain silicon nitride, and may be made of silicon.

In the ninth embodiment described above, an example in which heaters 5 provided in a one-side second core layer 40 and the other-side second core layer 50 function as a phase adjustment unit has been described, but the present disclosure is not limited thereto. For example, a PN phase shifter may be used as the phase adjustment unit. In this case, the PN phase shifter can be implemented by forming a PN junction in a one-side second tapered portion 44 and the other-side second core layer 50 and adjusting a refractive index of the one-side second core layer 40 and the other-side second core layer 50 by adjusting a carrier density of the PN junction using an applied voltage.

In the above-described embodiments, it is needless to mention that elements forming the embodiments are not necessarily essential unless otherwise particularly specified as being essential or deemed as being apparently essential in principle.

In the above-described embodiments, the present disclosure is not limited to a specific number of components of the embodiments, except in a case in which numerical values such as the number of components, numerical values, quantities, ranges, and the like are referred to, particularly a case in which the numerical values are specified as being essential and a case in which the numerical values are apparently limited to the specific number in principle, and the like.

In the above-described embodiments, when referring to the shape, positional relationship, and the like of a component and the like, the present disclosure is not limited to the shape, positional relationship, and the like, except in a case of being particularly specified, a case of being limited to a specific shape, a specific positional relationship in principle, and the like.

A control unit and a method thereof according to the present disclosure may be implemented by a dedicated computer provided by including a processor and a memory that are programmed to execute one or more functions embodied by a computer program. The control unit and the method thereof according to the present disclosure may be implemented by a dedicated computer provided by including a processor with one or more dedicated hardware logic circuits. The control unit and the method thereof according to the present disclosure may be implemented by one or more dedicated computers, each including a combination of a processor and a memory that are programmed to execute one or more functions and a processor formed of one or more hardware logic circuits. The computer program may be stored in a computer-readable non-transitory tangible recording medium as an instruction to be executed by a computer.

What is claimed is:

1. A spot size converter configured to emit a laser light in an emission direction, the spot size converter comprising:
a first core layer extending in a first direction along the emission direction and stacked on a cladding layer in a second direction; and
a second core layer extending in the first direction and spaced apart from the first core layer on at least one of one side and another side of the first core layer in a third direction orthogonal to the first direction and the second direction, wherein
the first core layer has a flat shape in which a size in the second direction is smaller than a size in the third direction, and includes a first tapered portion in which a size thereof in the third direction decreases along the emission direction,
the second core layer is formed such that a size thereof in the second direction is larger than the size of the first core layer in the second direction, and includes a second tapered portion in which a size thereof in the third direction increases along the emission direction, and
the second tapered portion is disposed at a position overlapping at least a part of the first tapered portion in the third direction.

2. The spot size converter according to claim 1, wherein
the first core layer is a single first core layer and has a first core surface adjacent to the cladding layer in the second direction,
the second core layer is stacked on the cladding layer and has a second core surface adjacent to the cladding layer in the second direction, and
the first core surface and the second core surface overlap in the second direction.

3. The spot size converter according to claim 1, wherein
the first core layer is one of a plurality of first core layers arranged in the second direction with the cladding layer interposed therebetween.

4. The spot size converter according to claim 3, wherein
the cladding layer is one of a plurality of cladding layers,
the plurality of first core layers are provided on respective ones of the plurality of cladding layers different from one another,
when a direction in which the plurality of first core layers in the second direction are sequentially provided is a stacking forward direction and a direction opposite to the stacking forward direction is a stacking reverse direction, the plurality of first core layers have a first core surface facing in the stacking reverse direction,
the second core layer is provided on the cladding layer on which a predetermined first core of the plurality of first core layers is provided, and has a second core surface facing in the stacking reverse direction, and
the first core surface and the second core surface overlap in the second direction.

5. The spot size converter according to claim 1, wherein
the second core layer is provided such that a size of an end portion thereof, which is opposite to the emission direction, in the third direction is smaller than a size in the second direction.

6. The spot size converter according to claim 1, wherein
an absolute value of variation of the first tapered portion in the third direction per unit length in the emission direction is larger than an absolute value of variation of the second tapered portion in the third direction per unit length in the emission direction.

7. The spot size converter according to claim 1, wherein
a position of an end portion of the first tapered portion, which is opposite to the emission direction, in the first direction matches a position of an end portion of the second tapered portion, which is opposite to the emission direction, in the first direction.

8. The spot size converter according to claim 1, wherein
a position of an end portion of the first tapered portion, which faces in the emission direction, in the first direction matches a position of an end portion of the second tapered portion, which faces in the emission direction, in the first direction.

9. The spot size converter according to claim 1, wherein
the second core layer includes a one-side second core layer provided on the one side of the first core layer in the third direction, and an other-side second core layer provided on the other side of the first core layer in the third direction.

10. The spot size converter according to claim 9, wherein
the one-side second core layer is stacked on the cladding layer and has a one-side second core surface adjacent to the cladding layer in the second direction,
the other-side second core layer is stacked on the cladding layer and has an other-side second core surface adjacent to the cladding layer in the second direction, and
the one-side second core surface and the other-side second core surface overlap in the second direction.

11. The spot size converter according to claim 9, further comprising:
a light combining portion configured to combine laser lights propagated through the one-side second core layer and the other-side second core layer; and
a third core layer configured to guide a laser light combined by the light combining portion to an outside of the spot size converter.

12. The spot size converter according to claim 11, wherein
the one-side second core layer includes a one-side combining portion on an end portion thereof in the emission direction, the one-side combining portion decreasing in size in the third direction along the emission direction,
the other-side second core layer includes an other-side combining portion on an end portion thereof in the emission direction, the other-side combining portion facing
the one-side combining portion in the third direction and decreasing in size in the third direction along the emission direction,
the third core layer includes a combined facing portion disposed between the one-side combining portion and the other-side combining portion, and
the light combining portion includes the one-side combining portion, the other-side combining portion, and the combined facing portion.

13. The spot size converter according to claim 12, wherein
a size of the combined facing portion in the third direction increases along the emission direction.

14. The spot size converter according to claim 12, wherein
the one-side second core layer includes a one-side inner bent portion that is bent to approach the combined facing portion on a side opposite to the emission direction with respect to the one-side combining portion to reduce a distance in the third direction between the one-side combining portion and the combined facing portion, and
the other-side second core layer includes an other-side inner bent portion that is bent to approach the combined facing portion on a side opposite to the emission direction with respect to the other-side combining portion to reduce a distance in the third direction between the other-side combining portion and the combined facing portion.

15. The spot size converter according to claim 11, further comprising:
a multi-mode interference device provided between the one-side second core layer and the other-side second core layer, and the third core layer in the first direction, wherein
the multi-mode interference device has an input side connected to end portions of the one-side second core layer and the other-side second core layer in the emission direction, and an output side connected to an end portion of the third core layer in a direction opposite to the emission direction, and
the light combining portion is implemented by the multi-mode interference device.

16. The spot size converter according to claim 15, wherein
the one-side second core layer includes a one-side outer bent portion, which is bent in the third direction to be spaced apart from the other-side second core layer, in front of a portion to which the multi-mode interference device in the emission direction is connected, and
the other-side second core layer includes an other-side outer bent portion, which is bent in the third direction to be spaced apart from the one-side second core layer, in front of a portion to which the multi-mode interference device in the emission direction is connected.

17. The spot size converter according to claim 11, further comprising:
a phase adjustment unit configured to adjust phases of the laser lights propagated through the one-side second core layer and the other-side second core layer, wherein
the phase adjustment unit is located on a side of at least one of the one-side second core layer and the other-side second core layer on which the light combining portion is disposed, in a direction opposite to the emission direction.

18. The spot size converter according to claim 17, wherein
the phase adjustment unit is implemented by a heater configured to heat the one-side second core layer and the other-side second core layer.

19. The spot size converter according to claim 1, wherein
the first core layer and the second core layer contain silicon nitride.
